(19) United States
(12) Patent Application Publication
(10) Pub. No.: US 2024/0109779 A1
(43) Pub. Date: Apr. 4, 2024

(54) SYSTEM AND METHOD FOR SILICON MATERIAL MANUFACTURING

(71) Applicant: ionobell, Inc., San Jose, CA (US)

(72) Inventors: Robert C. Ionescu, San Jose, CA (US); Chueh Liu, San Jose, CA (US)

(73) Assignee: ionobell, Inc., San Jose, CA (US)

(21) Appl. No.: 18/536,796

(22) Filed: Dec. 12, 2023

Related U.S. Application Data
(63) Continuation-in-part of application No. 18/096,280, filed on Jan. 12, 2023.
Application No. 18/096,280 is a continuation of application No. 17/525,769, filed on Nov. 12, 2021, now Pat. No. 11,584,653.
Application No. 17/525,769 is a continuation-in-part of application No. 17/322,487, filed on May 17, 2021, now Pat. No. 11,780,733.
Application No. 17/322,487 is a continuation of application No. 17/097,814, filed on Nov. 13, 2020, now Pat. No. 11,066,305.
(60) Provisional application No. 63/431,830, filed on Dec. 12, 2022.

(51) Int. Cl. C01B 33/02; H01M 4/36; H01M 4/38; H01M 4/583

(52) U.S. Cl. CPC C01B 33/02; H01M 4/366; H01M 4/386; H01M 4/583; B82Y 40/00

(57) ABSTRACT

A system can include one or more chambers, where a chamber can include an agitation mechanism, an activation source, and one or more ports (e.g., inlets and/or outlets). A method can include one or more of preparing a silica starting material, reducing the silica starting material, washing the silicon, and/or coating the silicon.

### CROSS-REFERENCE TO RELATED APPLICATIONS

This application is a continuation-in-part of U.S. patent application Ser. No. 18/096,280 filed 12 Jan. 2023, which is a continuation of U.S. patent application Ser. No. 17/525,769 filed 12 Nov. 2021, which is a continuation-in-part of U.S. patent application Ser. No. 17/322,487 filed 17 May 2021, which is a continuation of U.S. patent application Ser. No. 17/097,814 filed 13 Nov. 2020, each of which is incorporated in its entirety by this reference.

This application also claims the benefit of U.S. Provisional Application No. 63/431,830 filed 12 Dec. 2022, which is incorporated in its entirety by this reference.

### TECHNICAL FIELD

This invention relates generally to the silicon materials field, and more specifically to a new and useful system and method in the silicon materials field.

### BRIEF DESCRIPTION OF THE FIGURES

FIG. 1 is a schematic representation of the apparatus.

FIG. 2 is a schematic representation of the method.

FIGS. 3A-3F are schematic representations of examples of silicon particles.

FIGS. 4A-4C are schematic representations of examples of silicon material.

FIGS. 5A and 5B are schematic representations of examples of reaction chambers.

FIGS. 6A and 6B are schematic representations of examples of horizontally and vertically oriented reaction chambers respectively.

FIG. 7 is a schematic representation of an example of collecting a reagent or reagent byproduct during washing.

FIG. 8 is a flow chart representation of an example of the method.

FIGS. 9A-9C are schematic representations of examples of temperature profiles during the reduction of silica.

FIGS. 10A and 10B are schematic representations of examples of rotation rates profiles during the reduction of silica and/or coating of silicon.

FIG. 11 is a schematic representation of an exemplary spiral powder mixer.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

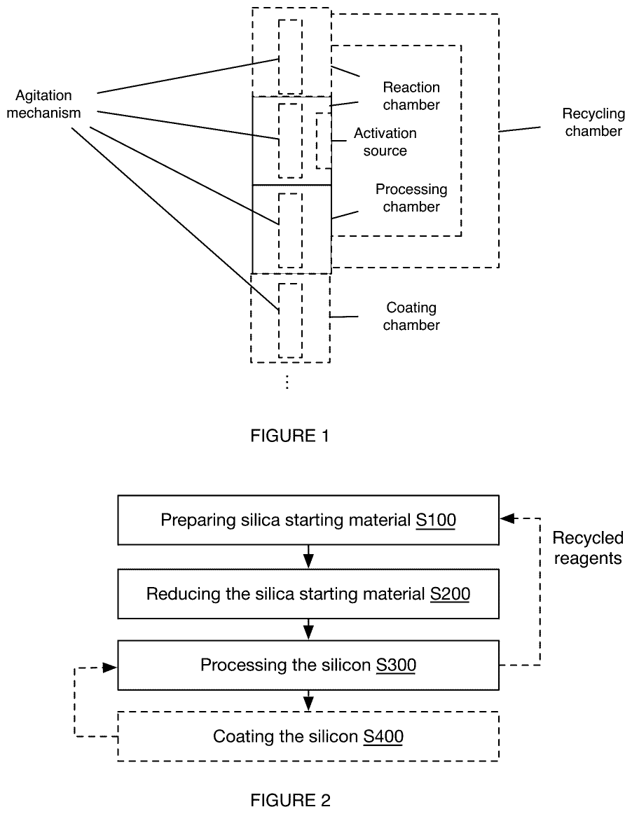

As shown in FIG. 1, the system can include one or more chambers. A chamber can include an agitation mechanism, an activation source, one or more ports (e.g., inlets and/or outlets), and/or any suitable components. Exemplary chambers include: reaction chambers, washing chambers, coating chambers, recycling chambers, holding (e.g., storage) chambers, comminution chambers (e.g., milling chambers, ball mills, etc.), and/or any suitable chambers.

As shown in FIG. 2, the method can include preparing a silica starting material S100, reducing the silica starting material S200, processing the silicon S300, coating the silicon S400, and/or any suitable steps.

The system and/or method preferably function to manufacture a silicon material, but can additionally or alternatively be used (e.g., to manufacture any suitable material). The silicon material is preferably used as (e.g., included in) an anode material (e.g., an anode slurry) in a battery (e.g., a Li-ion battery). However, the silicon material can additionally or alternatively be used for photovoltaic applications (e.g., as a light absorber, as a charge separator, as a free carrier extractor, etc.), as a thermal insulator (e.g., a thermal insulator that is operable under extreme conditions such as high temperatures, high pressures, ionizing environments, low temperatures, low pressures, etc.), for high sensitivity sensors (e.g., high gain, low noise, etc.), as a radar absorbing material, as insulation (e.g., in buildings, windows, thermal loss and solar systems, etc.), for biomedical applications, for pharmaceutical applications (e.g., drug delivery), as an aerogel or aerogel substitute (e.g., silicon aerogels), and/or for any suitable application. For some of these applications, the silicon material can be oxidized into silica (e.g., SiO₂ that retains a morphology substantially identical to that of the silicon material), used as silicon, nitrogenated (e.g., into a silicon nitride such as Si₃N₄, Si₂N, SiN, Si₂N₃, SiNₓ, SiₓN, etc.), halogenated (e.g., with fluorine, chlorine, bromine, iodine, astatine, combinations thereof), hydrogenated (e.g., such as SiH₄), sulfonated (e.g., as SiS₂), thiosilicate, oxynitrides, carbide (e.g., silicide carbide, carborundum, etc.), and/or have any suitable composition. The silicon can be oxidized, for example, by heating the silicon material (e.g., in an open environment, in an environment with a controlled oxygen or other oxidizing agent content, etc.) to between 200 and 1000° C. for 1-24 hours. However, the silicon could be oxidized using an oxidizing agent and/or otherwise be oxidized.

### 2. Benefits.

Variations of the technology can confer several benefits and/or advantages.

First, variants of the technology can enable reproducible (e.g., between batches, within a given batch, etc.) silicon material manufacture such as to produce substantially the same silicon material each time the technology is used. The inventors have found that magnesiothermal reduction of silica can lead to difficult to repeatably and/or replicably form silicon material (e.g., different surface areas, different morphologies, different particle sizes, different pore volumes, different pore shapes, etc.). In specific examples, the inventors have found that enhanced reproducibility can be achieved by: maintaining a consistent temperature, agitating the reagents (e.g., silica, reducing agents, salts, etc.) throughout the reduction, including pretreatment steps, preparing the silica starting material (e.g., milling the silica starting material), controlling a reagent concentration (e.g., a relative reagent concentration), and/or can otherwise enhance the reproducibility of the silicon material formation.

Second, variants of the technology can enable green chemistry and/or low waste processes. For example, the technology can recycle and/or use silica starting materials generated from upstream manufacturing processes, can capture (and reuse) reagents used in the process (e.g., capture and reuse reducing agents such as Mg), and/or can otherwise facilitate low waste processing.

Third, variants of the technology can enable manufacturing scale preparation of materials. For example, variants of the technology can enable manufacture of kilogram (or greater such as tonne, megagram, etc.) quantities of silicon material to be manufactured (e.g., with high uniformity such as a narrow size distribution, narrow pore size distribution, narrow pore volume distribution, etc.).

However, variants of the technology can confer any other suitable benefits and/or advantages.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30%, etc. of a reference), or be otherwise interpreted.

### 3. System.

The system preferably functions to generate a silicon material, but can additionally or alternatively function to form another material (e.g., with a structure similar to the silicon material). The silicon material can include one or more dopant(s), stabilizing agents, and/or other suitable inclusions. However, the silicon material can additionally or alternatively be substantially pure and/or have any suitable composition. In specific examples (e.g., as disclosed in U.S. patent application Ser. No. 18/096,280, titled ‘SILICON MATERIAL AND METHOD OF MANUFACTURE’ filed 12 Jan. 2023 which is incorporated in its entirety by this reference), the silicon material can have a composition of: Si, SiOₓ, SiOC, SiC, SiₓOₓC, SiₓOₓC_{y}, SiOₓC_{y}, SiₓC_{y}, SiOₓ, SiₓO_{y}, SiO₂C, SiO₂Cₓ, SiOCZ, SiCZ, SiₓO_{y}CZ, SiₓOₓCₓZₓ, SiₓCₓZ_{y}, SiOₓZₓ, SiₓOₓZ_{y}, SiO₂CZ, SiO₂CₓZ_{y}, and/or have any suitable composition (e.g., include additional element(s)), where Z can refer to any suitable element of the periodic table and x and/or y can be the same or different and can each be between about 0.001 and 2 (e.g., 0.001, 0.005, 0.01, 0.05, 0.1, 0.5, 1, 2, 0.001-0.05, 0.01-0.5, 0.01-0.1, 0.001-0.01, 0.005-0.1, 0.5-1, 1-2, values or ranges therebetween etc.), less than 0.001, or greater than 2.

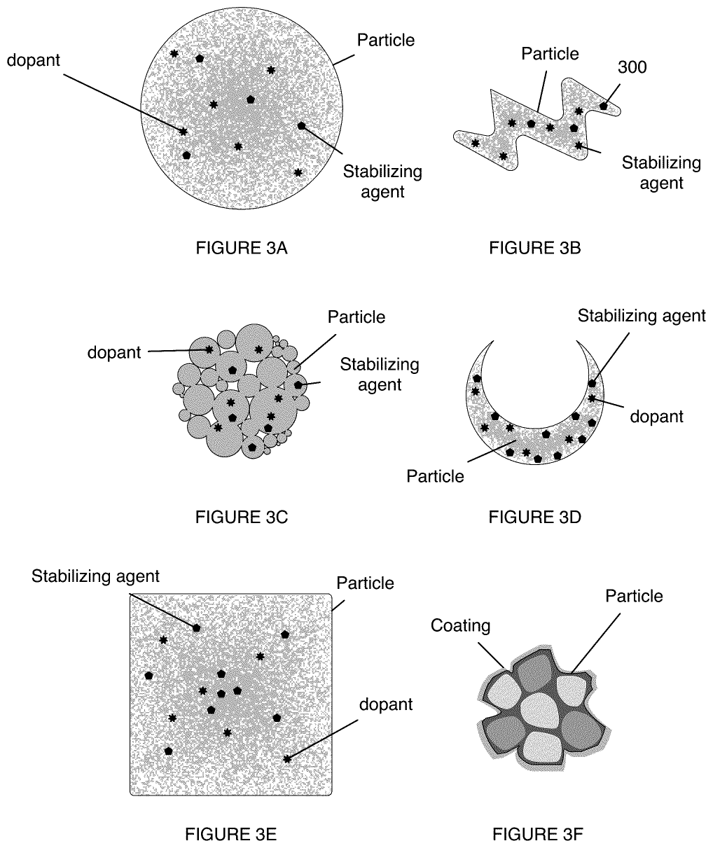

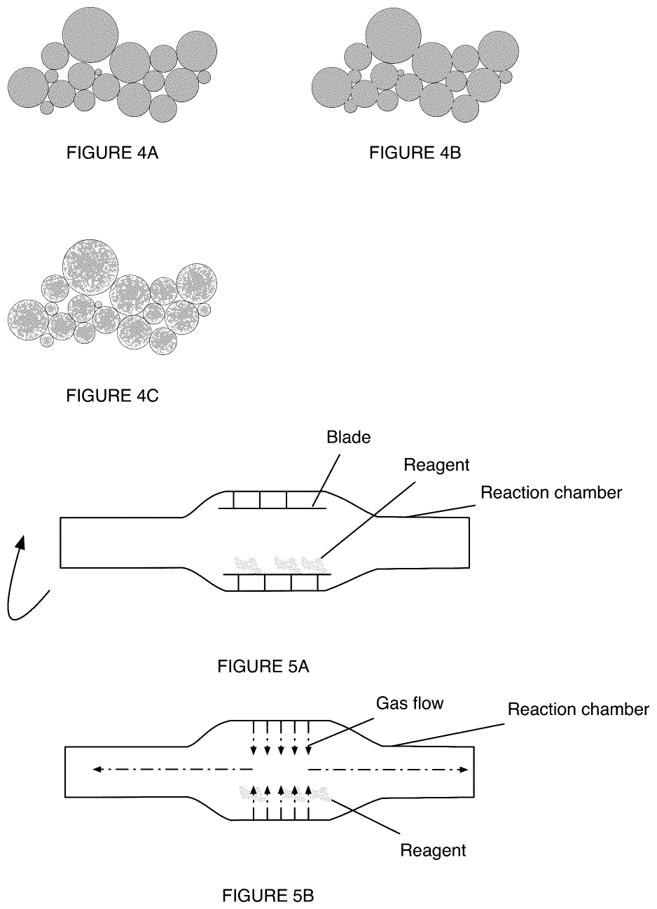

The silicon material can include particles (e.g., solid particles, porous particles, hollow particles, etc. such as nanoparticles, mesoparticles, microparticles, macroparticles, as shown for example in FIGS. 3A-3F, etc.), clusters (e.g., particle aggregates, as shown for example in FIGS. 4A-4C, etc.), agglomers (e.g., aggregates of particle aggregates), films, and/or any suitable structures. The silicon material (and/or silicon thereof) can be amorphous, crystalline (e.g., polycrystalline, monocrystalline, pseudocrystalline, etc.), and/or have any suitable structure.

The silicon material preferably has an external expansion (e.g., volumetric expansion, areal expansion, linear expansion along one more directions, etc. such as resulting from lithiation, thermal expansion, metalation, etc.) less than about 50% (e.g., compression such as a negative expansion, 0%, 5%, 10%, 20%, 30%, 40%, 50%, values or ranges therebetween, etc.), but can be greater than 50%. The external expansion can be achieved, for instance, by enabling internal expansion (e.g., an internal void space) within the silicon material where the silicon material can expand internally (e.g., before, in addition to, in the alternative to, etc. expanding externally such as into an external environment proximal the silicon material). However, the external expansion can otherwise be achieved (e.g., by modifying a lattice constant, density, or other properties of the silicon material, by accommodating stress such as using a dopant or dopant particles to accommodate expansion stress, etc.).

The surface area of the exterior surface (e.g., an external surface area) of the silicon material (e.g., an exterior surface of the particles, an exterior surface of a cluster of particles, an exterior surface of an agglomer of particles and/or clusters, etc.) is preferably small (e.g., less than about 0.01, 0.5 m²/g, 1 m²/g, 2 m²/g, 3 m²/g, 5 m²/g, 10 m²/g, 15 m²/g, 20 m²/g, 25 m²/g, 30 m²/g, 50 m²/g, values or between a range thereof), but can be large (e.g., greater than 50 m²/g) and/or any suitable value.

The surface area of the interior (e.g., an internal surface area) of the silicon material (e.g., a surface exposed to an internal environment that is separated from with an external environment by the exterior surface, a surface exposed to an internal environment that is in fluid communication with an external environment across the exterior surface, interior surface, etc. such as within a particle, cooperatively defined between particles, between clusters of particles, between agglomers, etc.) is preferably large (e.g., greater than 10 m²/g, 15 m²/g, 20 m²/g, 25 m²/g, 30 m²/g, 50 m²/g, 75 m²/g, 100 m²/g, 110 m²/g, 125 m²/g, 150 m²/g, 175 m²/g, 200 m²/g, 300 m²/g, 400 m²/g, 500 m²/g, 750 m²/g, 1000 m²/g, 1250 m²/g, 1400 m²/g, ranges or values therebetween, >1400 m²/g), but can be small (e.g., less than about 10 m²/g). However, the internal surface area can be above or below the values above, and/or be any suitable value.

In variants, the pore characteristics can be determined or measured using direct measurements (e.g., determining a bulk volume and a volume of the skeletal material without pores), nitrogen absorption, intrusion porosimetry (e.g., mercury-intrusion porosimetry), computed tomography, optical methods, water evaporation methods, gas expansion methods, thermoporosimetry, cryoporometry, and/or using any suitable method(s). In some variants, the surface area can refer to a Brunner-Emmett-Teller (BET) surface area. However, any definition, theory, and/or measurement of surface area can be used. The surface area can be determined, for example, based on calculation (e.g., based on particle shape, characteristic size, characteristic size distribution, etc. such as determined from particle imaging), adsorption (e.g., BET isotherm), gas permeability, mercury intrusion porosimetry, and/or using any suitable technique. In some variations, the surface area (e.g., an internal surface area) can be determined by etching the external surface of the material (e.g., chemical etching such as using nitric acid, hydrofluoric acid, potassium hydroxide, ethylenediamine pyrocatechol, tetramethylammonium hydroxide, etc.; plasma etching such as using carbon tetrafluoride, sulfur hexafluoride, nitrogen trifluoride, chlorine, dichlorodifluoromethane, etc. plasma; focused ion beam (FIB); etc.), by measuring the surface area of the material before fusing or forming an external surface, and/or can otherwise be determined. However, the surface area (and/or porosity) can be determined in any manner.

In specific examples, the silicon material can be a silicon material as disclosed in U.S. patent application Ser. No. 17/322,487 titled ‘POROUS SILICON AND METHOD OF MANUFACTURE’ filed 17 May 2021, and/or U.S. patent application Ser. No. 17/525,769 titled “SILICON MATERIAL AND METHOD OF MANUFACTURE’ filed 12 Nov. 2021, each of which is incorporated in its entirety by this reference.

In variants of the silicon material that are coated, the coating can function to modify (e.g., enhance, increase, decrease, etc.) an electrical conductivity of the silicon material, improve the stability of the silicon material (e.g., stability of the silicon, stability of an interfacial layer that forms proximal the surface of the silicon such as a solid electrolyte interphase (SEI) layer, etc.), and/or can otherwise function.

The coating (e.g., coating material, coating thickness, etc.) can be selected based on one or more of: the ability of the coating to form a stable interface between an interfacial layer (e.g., an SEI layer, an active material, a battery surface, etc.) and the silicon, ability to inhibit formation of an interfacial layer, coating stability (e.g., stability in an oxidizing environment, stability in a reducing environment, stability in a reactive environment, stability to reaction with specific reactive agents, etc.), electrical conductivity (e.g., electrical conductivity of the coating, target electrical conductivity of the coated silicon, electrical insulative properties, etc.), ion diffusion rate (e.g., Li⁺ diffusion rate through the coating; ion conductivity), coating elasticity, silicon porosity, silicon expansion coefficient (e.g., external expansion coefficient, external volumetric expansion, etc.), SEI layer formation (e.g., promotion and/or retardation), and/or otherwise be selected.

The coating can attach to an outer surface of the silicon, infiltrate the pores, coat a portion of the silicon (e.g., portion of the silicon possessing a predetermined quality), and/or otherwise coat the silicon.

The coating material preferably includes carbonaceous material (e.g., organic molecules, polymers, inorganic carbon, nanocarbon, amorphous carbon, etc.), but can additionally or alternatively include inorganic materials, plasticizers, biopolymeric membranes, ionic dopants, and/or any suitable materials. Examples of polymeric coatings include: pitch (e.g., bitumen, asphalt, resin, tar, coal tar, pine tar, etc.), polyacrylonitrile (PAN), polypyrrole (PPy), unsaturated rubber (e.g., polybutadiene, chloroprene rubber, butyl rubber such as a copolymer of isobutene and isoprene (IIR), styrene-butadiene rubber such as a copolymer of styrene and butadiene (SBR), nitrile rubber such as a copolymer of butadiene and acrylonitrile, (NBR), etc.), saturated rubber (e.g., ethylene propylene rubber (EPM), a copolymer of ethene and propene; ethylene propylene diene rubber (EPDM); epichlorohydrin rubber (ECO); polyacrylic rubber such as alkyl acrylate copolymer (ACM), acrylonitrile butadiene rubber (ABR), etc.; silicone rubber such as silicone (SI), polymethyl silicone (Q), vinyl methyl silicone (VMQ), etc.; fluorosilicone rubber (FVMQ); etc.), and/or any suitable polymer(s). Examples of carbonaceous coatings include: carbon super P, acetylene black, carbon black (e.g., C45, C65, etc.), mesocarbon microbeads (MCMB), graphene, carbon nanotubes (CNTs) (e.g., single walled carbon nanotubes, multiwalled carbon nanotubes, semi-conducting carbon nanotubes, metallic carbon nanotubes, etc.), reduced graphene oxide, graphite, fullerenes, and/or any suitable coating materials. The coating can include a mixture of coating materials, where the ratio and/or relative amounts of the constituents can be selected based on any suitable coating property.

The coating can be electrically insulating, semiconducting, electrically conductive, and/or have any suitable electrical properties. The coating is preferably ionically conductive (e.g., enables the diffusion or transport of ions through), but can be ionically insulating. In some variants, when the coating swells (e.g., in response to expansion of the silicon material), the ionic conductivity of the coating can be increased.

The coating thickness is a value or range thereof preferably between about 1 nm and 20 μm such as 1 nm, 2 nm, 3 nm, 5 nm, 10 nm, 20 nm, 30 nm, 50 nm, 100 nm, 200 nm, 500 nm, 1 μm, 2 μm, 5 μm, 10 μm, or values or ranges therebetween. However, the coating thickness can be less than 1 nm or greater than 20 μm. The coating thickness can be substantially uniform (e.g., thickness vary by at most 1%, 2%, 5%, 10%, 20%, etc.; homogeneous; etc.) or nonuniform (e.g., inhomogeneous) over the extent of the silicon material. For instance, the coating thickness can form a thickness gradient such as being thicker closer to the external exposed surface of the silicon material. In another example, the coating can have a first thickness on internal surfaces of the silicon material and a second thickness (generally, but not always, greater than the first thickness) on external surfaces of the silicon material. In another example, the coating thickness can be between about 1 nm and about 1 μm (e.g., 1-10 nm, 1-100 nm, 10-100 nm, 20-50 nm, 25-100 nm, 1-25 nm, 1-20 nm, 2-10 nm, 5-10 nm, 50-100 nm, 50-500 nm, 0.9-1100 nm, 0.8-1200 nm, etc.; over an external surface of the silicon; over an internal surface of the silicon; over an exposed surface such as internal and/or external surface of the silicon; etc.). The coating thickness is preferably chosen to allow ions (e.g., Li⁺ ions) and/or other materials (e.g., electrolytes) to penetrate the coating. However, the coating can be impenetrable to ions, can include one or more pores and/or perforations to enable the materials (e.g., ions) to pass through (e.g., at predetermined locations), and/or otherwise be permeable to one or more substances. The coating thickness can depend on the coating material, the material of one or more other coatings, the silicon material, and/or otherwise depend on the silicon material.

Typically, the coated silicon material has a lower surface area than the uncoated silicon material. For instance, the external surface area of coated silicon material can be between 1.5× and 20× (inclusive of any value therebetween) lower than that of the uncoated silicon material.

In specific examples, the coated silicon material can be a coated silicon material as disclosed in U.S. patent application Ser. No. 17/890,863 titled ‘SILICON MATERIAL AND METHOD OF MANUFACTURE’ filed 18 Aug. 2022, which is incorporated in its entirety by this reference.

The system can be implemented as a batch processing, continuous processing, and/or other processing stream for manufacturing the silicon material. The system can operate automatically (e.g., moving between manufacturing steps, processes, stages, etc. without user input such as using robotics, automated gates, automated valves, computer-controlled instructions, etc.), semi-automatically (e.g., responsive to one or more user inputs), manually (e.g., based on user input settings, user transitioning from one stage to another, etc.), and/or in any manner. The system can be implemented as (e.g., integrated into) a belt furnace, tube furnace, vacuum furnace, sintering furnace, retort furnace, drop-bottom furnace, rotary furnace, rotary kiln, rotary oven, spiral powder mixer such as shown for example in FIG. 11, and/or in any manner (e.g., include heating elements arranged or configured in any manner to heat reagents). In a specific example, the system can be implemented as a throughput continuous spinning tube base system. In another example, the system (or chambers thereof) can include mixing blades to mix material (e.g., while heating, while cooling), where material can be passed along the system vertically (e.g., parallel to a gravity vector), horizontally (e.g., perpendicular to a gravity vector), and/or with any suitable angle to a gravity vector.

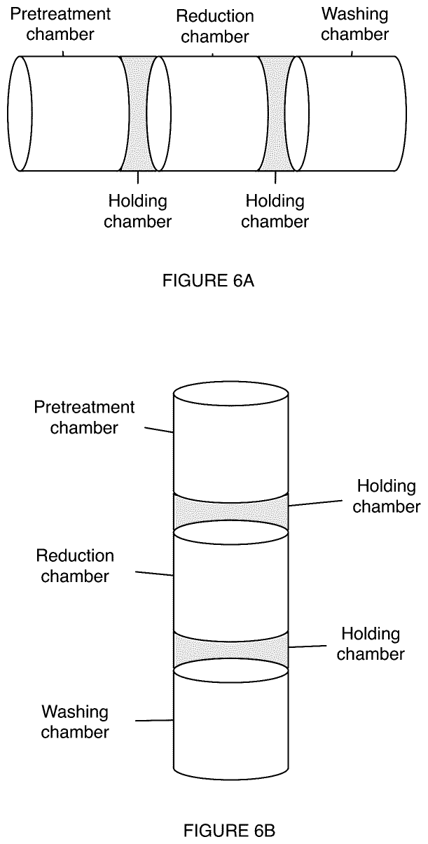

The system can be a fully connected or integrated system, a segmented system, include separated compartments (e.g., chambers), and/or can otherwise be configured. The system can be arranged vertically (e.g., where different processing stages are performed at different heights, oriented parallel to a gravity vector, as shown for example in FIG. 6B, etc. where gravity can be used or leveraged in transitioning material between compartments), horizontally (e.g., different processing stage performed at different lateral locations, oriented approximately perpendicular to a gravity vector, as shown for example in FIG. 6A, etc.), and/or have any suitable arrangement (e.g., any angle relative to a gravity vector, plurality of orientations, etc.).

The environment within the system (e.g., where the system substantially isolates the internal environment from an external environment proximal the system) is preferably inert (e.g., does not react, does not substantially react with silicon in conditions present within the system, does not substantially react with silica in conditions present within the system, etc.), but can be reactive and/or have any suitable conditions. Examples of inert environments include: vacuum (e.g., low pressure environment such as less than 500 Pa, 100 Pa, 10 Pa, 1 Pa, 100 mPa, 10 mPa, 1 mPa, 100 μPa, 10 μPa, 1 μPa, values therebetween, <1 μPa, etc.), noble gases (e.g., helium, neon, argon, krypton, xenon, radon, etc.), non-reactive gases (e.g., carbon dioxide, nitrogen, etc.), and/or other suitable environments (e.g., reactive gases such as gaseous magnesium, gaseous alkali metal, gaseous sulfur, etc.). The environment can be static (e.g., same materials present throughout the duration of the reaction and/or process(s) performed in the system) and/or dynamic (e.g., change throughout the processing). The environment can be the same for different processes (e.g., within different chambers) and/or different for different processes (e.g., a different environment in each chamber).

The system is preferably implemented in a multi-chamber arrangement (e.g., where each chamber can be used for to perform one or more process). The chambers are preferably connected to each other (e.g., vertically stacked, horizontally connected, as shown for example in FIG. 6A or 6B, such as to enable materials to directly pass between chambers, to enable reagents to pass between chambers contingent on one or more conditions, etc.), but can be separated (e.g., where materials can be transported between chambers via manifolds, through open air, by robotics, by pneumatics, by rail systems, etc.). However, the system can be implemented in a single chamber arrangement (e.g., with access to rapid heating and/or cooling, access to rapid environment changes, etc.) and/or any suitable arrangement.

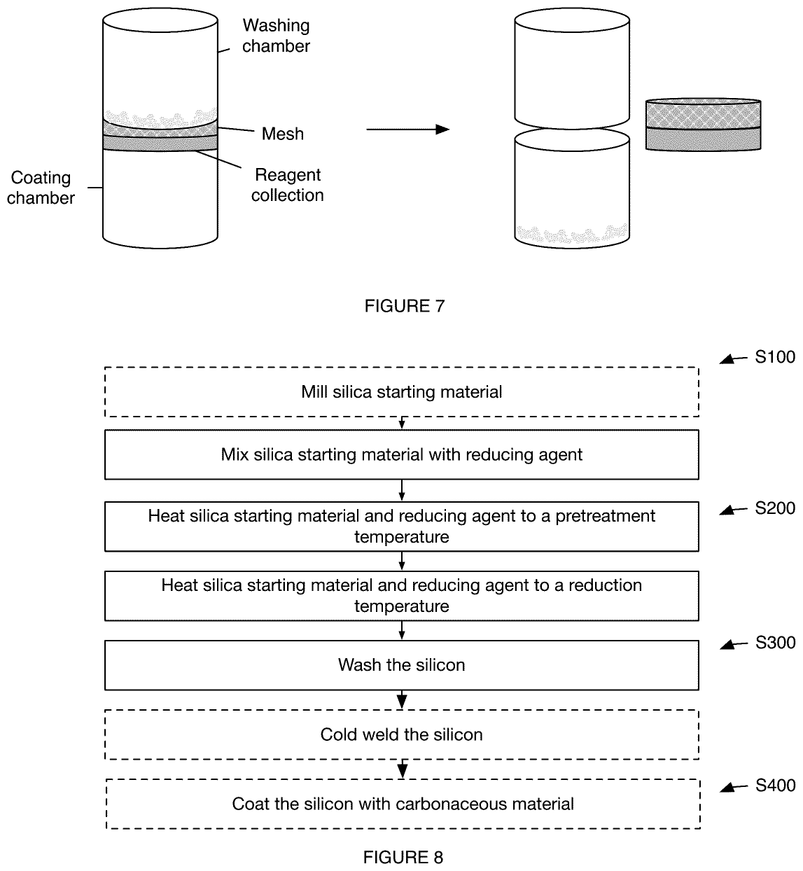

The chamber(s) 100 (e.g., chamber walls) can be made of stainless steel, carbon steel, aluminium, ceramics (e.g., titania), titanium, metals, alloys, composites, and/or any suitable material(s) (e.g., rust resistant materials). The chamber walls can be solid (e.g., hinder, prevent, etc. ingress or egress of species), porous, mesh, and/or have any suitable structure. The chambers preferably include one or more inlets and outlets. For example, a chamber can include a gas inlet (e.g., configured to introduce a gas such as an inert gas, reactive agent, magnesium vapor, aluminium vapor, reducing agent vapor, etc.), an outlet (e.g., connected to vacuum pump, configured to evacuate the chamber volume, etc.), and/or any suitable ports. In another example, as shown for instance in FIG. 7, a wall or surface of a chamber can be configured to allow molten or dissolved materials to pass through without (or with less) solid material passing through (e.g., a mesh, a porous material, etc.). However, the chamber walls can be configured in any manner.

Reagents (e.g., silica, silicon, reducing agents, salts, reaction modifiers, coating materials, reaction byproducts, washing agents, washing byproducts, gases, etc.) can be introduced and/or expelled through a top, bottom, side, edge, corner, port, and/or other location of a chamber. For example, gases (e.g., to maintain an environment, to mix the reagents, etc.) can be introduced from one or more side walls of a chamber (e.g., as shown for example in FIG. 5B). In another example, reagents (e.g., silica, reducing agents, silicon, etc.) can be introduced through a top of the chamber and expelled through a bottom of the chamber (e.g., as shown for example in FIG. 6B). However, inlets and/or outlets can be arranged in any manner.

Inlets and/or outlets preferably include a valve, door, and/or other mechanism for controlling an open vs closed state of the chamber, but can be permanently opened (e.g., where ingress or egress is controlled by an action of an agitation mechanism, by a gas flow rate, etc.), and/or can otherwise be arranged.

A chamber can be cylindrical, polyhedral (e.g., cubic, rectangular prism, prismatoid, etc.), spherical, hemispherical, toroidal, annular, and/or can have any suitable shape. A lateral and/or longitudinal extent (e.g., radius, length, width, etc.) of a chamber is preferably 1-500 mm (e.g., 6 in, 8 in, 10 in, 12 in, 16 in, 18 in, 24 in, etc.), but can be smaller than 1 mm or larger than 500 mm. An extent perpendicular to the lateral and/or longitudinal extent (e.g., a height) of a chamber is preferably between 1 foot and 50 feet (e.g., 2 ft, 4 ft, 8 ft, 10 ft, 15 ft, 20 ft, 25 ft, etc.), but can be less than 1 foot or greater than 50 feet.

A chamber volume often includes a working volume and a non-working volume, where a chamber process preferably occurs predominantly in the working volume (and where the non-working volume is generally empty or otherwise has less process occurring therewithin). However, the entire chamber volume can be as working volume and/or the chamber volume can otherwise be arranged. The processing conditions (e.g., temperature; reagent concentration such as silica/silicon concentration, reducing agent concentration, etc.; pressure; etc.) within the working volume are preferably substantially constant (e.g., condition gradients approximately 0, constant properties, etc.) but can include gradients (e.g., intentional condition gradients such as to progress a reaction as material passes through), and/or have any suitable processing conditions. The processing conditions within the non-working volume(s) are generally ill-controlled (e.g., can have substantial gradients, differ from target processing conditions, etc.), but can be well-controlled (e.g., have small gradients, have similar conditions to the working volume, etc.). The working volume can be proximal (e.g., near) a central portion of the chamber (e.g., along a height, along a length, along a width, etc.), proximal a wall or edge of the chamber, and/or can otherwise be arranged within the chamber. As an illustrative example a reduction chamber can have a temperature zone that is approximately half the height of the reduction chamber. The temperature within the temperature zone is preferably approximately constant (e.g., varies by at most ±20° C., ±10° C., ±5° C., ±2° C., ±1° C., ±0.5° C., ±0.1° C., etc. between a hottest and coldest portion of the temperature zone). The temperature can be less well controlled outside the temperature zone. The temperature zone is typically the central half of the height (e.g., a first quarter and last quarter along the height direction can be less well controlled), but can be at any height or extent along the height of the chamber (e.g., proximal a ‘top,’ ‘bottom,’ entrance, exit, etc.).

Chamber environments are preferably not shared (e.g., except during reagent or material transfer between chambers), but can be shared (e.g., a common system environment).

The chamber(s) can continuously be maintained in target chamber conditions (e.g., except for maintenance, whether reagents are present or not, etc.), intermittently in reaction conditions (e.g., only when reagents are present, when reagents are to be added within a threshold time, etc.), and/or can otherwise be held in their chamber conditions. Examples of properties of chamber conditions include: pressure, temperature, fill factor (e.g., extent of chamber volume, working volume thereof, etc. filled with reagents), agitation (e.g., agitation state), rotation speed, and/or any suitable conditions.

Chambers can include activation sources 200 which can function to input energy, chemicals, and/or other suitable reagents to facilitate one or more reaction or process. The activation sources can be integrated into a chamber wall, inside the chamber (e.g., symmetrically within the chamber such as centrally located within the chamber, along an interior surface such as a top of the chamber, etc.), be separated from the chamber wall (e.g., exterior to and not directly incorporated with the chamber wall), provided by an environment injected into the chamber (e.g., heated and/or cooled air, gas, solvent, materials, etc. that is/are provided to the chamber), integrated into an agitation mechanism (e.g., electrical heating blade), and/or can otherwise be arranged or configured. However, the activation source(s) can otherwise be arranged.

Exemplary activation sources include: thermal management elements 250 (e.g., heating elements, cooling elements), milling media, inlets and/or outlets, plasma generators, light sources (e.g., UV sources, x-ray sources, etc.), and/or other suitable activation sources. In some variants, the activation sources (e.g., a thermal management element) can move (e.g., rotate) such as to provide more uniform deliver of the activation element.

Exemplary chambers 100 can include: reaction chambers (e.g., pretreatment chamber no, reduction chamber 120, etc. such as a chamber where silica is reduced to silicon), washing chambers 131 (e.g., a chamber where one or more reaction byproduct from the silicon is removed from the silicon), coating chambers 140 (e.g., a chamber where the silicon is coated with a carbonaceous coating such as polymer, graphite, graphene, graphene oxide, carbon nanotube, fullerene, etc.; a lithium coating such as an SEI layer; an oxygen coating such as an oxide layer; etc.), preprocessing chambers no (e.g., milling chamber, comminution chamber), postprocessing chambers 130 (e.g., cold-welding chamber 132, milling chamber 133, etc.), separation chambers 134 (e.g., a chamber where one or more reagents are separated such as to isolate silicon from reducing agents, reaction byproducts, solvent(s), etc.), holding chambers 105 (e.g., functional to hold one or more reagents between processes or chambers), a recycling chamber 150 (e.g., a chamber where one or more byproducts is converted back into a reactive reagent such as to recover magnesium from magnesium chloride), and/or any suitable chamber(s) can be included.

In an illustrative example, as shown for instance in FIG. 1, a system can include a pretreatment chamber that connects to (e.g., empties into) a reduction chamber that connects to (e.g., empties into) a washing chamber that connects to (e.g., empties into) a coating chamber. In this illustrative example, byproducts of the reduction can be collected in a recycling chamber (as part of the washing chamber or washing process), where the byproducts and/or wash products can be converted back into reagents (e.g., magnesium or aluminium chloride can be converted back into magnesium or aluminium for use as reducing agent; silane can be captured and used to form additional silicon and/or silica; etc.) and reintroduced into the pretreatment chamber and/or reduction chamber. In this illustrative example, holding chambers are preferably included between each chamber where the holding chambers can function to hold reagents until a condition is met where the reagents are to be introduced in subsequent chambers. Exemplary conditions include: time, temperature, mass, volume, concentration, pressure, atmosphere composition (e.g., until an atmosphere is purged), oxidation extent, reduction extent, predicated on a parameter for a preceding chamber (e.g., has material within a reducing chamber finished reducing, has material been within the reducing chamber for a threshold time, etc.), predicated on a parameter for a subsequent chamber (e.g., has material within a reducing chamber finished reducing, has material been within the reducing chamber for a threshold time, etc.), and/or any suitable condition can be used. In this specific example, the pretreatment chamber (e.g., a working region thereof) can be maintained at approximately 700° C., the reduction chamber (e.g., a working region thereof) can be maintained at approximately 800° C., the wash chamber (e.g., a working region thereof) can be at a temperature between about 0° C. and 800° C. (for instance, when washing agents are first introduced, the washing chamber can be at a lower temperature such as 0-100° C. to lower a risk an exothermic reaction between the silicon and/or byproducts and the washing reagents causes changes to the silicon material, and raise the temperature close to or above a melting, vaporization, and/or sublimation temperature of washing byproducts, salts, etc.), and the coating chamber (e.g., a working region thereof) can be between about 0° C.-100° C. However, the chambers can be at any suitable temperature. In a variation of this specific, a cold-welding chamber (e.g., ball mill) can be included (e.g., after the washing chamber, after the coating chamber, etc.) which can function to weld the silicon particles together (e.g., resulting in larger effective particles sizes, reduced external surface area, sealing empty volume within aggregates of silicon particles, etc.).

One or more chambers can include an agitation mechanism 200, which functions to continuously move reagents within the chambers, hinder or prevent reagents from sticking to chamber walls, and/or can otherwise function. The agitation mechanism can be beneficial for reducing local heating within the chamber(s) (e.g., within reagents), and may in some embodiments reduce or even eliminate the need for salt during the silica reduction. The agitation mechanism can include blades (e.g., linear blades, helical blades, as shown for example in FIG. 5A, etc. such as connected to a motor to rotate, translate, etc. the blade), magnetic stirrers, cross-stirrers, vortex mixers, drum mixers, shakers, air currents (e.g., air flow paths, turbulators, etc. to inject and/or modify air currents within the chamber(s), as shown for example in FIG. 5B, etc.), and/or any suitable agitator(s) can be used. In some embodiments, the system (and/or chambers thereof) can be rotated, shaken, translated, and/or otherwise be actuated to produce agitation. For example, a chamber can be, include, and/or function as a rotating or spinning barrel. In variations of this example, a barrel can be removed from the chamber (e.g., to transport to a washing station) to allow another barrel to be slotted into the chamber. Typically, the rotation speed in these variants will be between about 100 and 1000 rpm (e.g., to ensure that the reagents are moving sufficiently rapidly). However, the rotation speed can be less than 100 rpm (e.g., 1 rpm, 5 rpm, 10 rpm, 50 rpm, etc.) or greater than 1000 rpm. In some variants, the rotation speed can be variable. For instance, the rotation speed can be related to (e.g., depend on, be a function of, etc.) a temperature of the chamber (e.g., set temperature, instantaneous temperature, etc.).

In variants of the agitation mechanism, the system (or chambers thereof) can be a fluidized bed (e.g., stationary fluidized bed, in bubbling fluidized bed, circulating fluidized bed, vibratory fluidized bed, mechanically fluidized reactor, annular fluidized bed, transport reactor, etc.). The fluidized bed can confer a further technical advantage of potentially enabling separation of reagents (e.g., based on different masses, different shapes, different drag profiles, different density, etc.) as the reagent(s) can be maintained at different equilibrium positions within the bed (e.g., to be collected for example using a collector plate at a given position). For instance, silicon with particular flow properties (e.g., resulting from mass, density, porosity, drag profiles, shapes, annealing, external surface area, characteristic size, etc.) can be collect.

In some variations, counter-rotating blades (e.g., counter rotating helical blades) can be used to agitate reagents, bring (and/or maintain) the reagents in working zone of a chamber, and/or can otherwise be used.

A plurality of agitation mechanisms can be used together. For instance, a chamber can include a blade mechanism and a fluidized bed (e.g., air flow configured to agitate and/or mix the reagents). Similarly, a mixing blade mechanism can be combined with a rotating chamber. However, any suitable agitation mechanism(s) can be used.

The system can optionally include a plasma source which can function to promote or facilitate plasma generation within the system. Plasma generation can be beneficial for decreasing a reaction temperature, decreasing a reaction time, enabling gaseous introduction of reagents, promoting uniform reactions and/or coatings (e.g., in isolation and/or in combination with agitation mechanisms), and/or can provide any suitable technical advantage. Examples of plasma sources include DC power supplies, AC power supplies, microwaves, radio frequency (RF) sources, and/or any suitable plasma source can be used.

In some variants, the plasma generation can function as an agitation mechanism. For example, a plasma sheath can be formed around the silica or silicon materials (e.g., particle, clusters, aggregates, etc.) which can create a space charge region between the individual species (resulting in electrostatic or electrodynamically driven motion between silicon particles).

When the system is closed (e.g., during reduction, during processing, during sealing, when reagents are not being transferred, etc.), there is preferably substantially no air flow (e.g., between chambers, between an external environment and the internal environment, etc.). When the system is closed, the chamber is preferably under vacuum (e.g., to a pressure between about 400-650 Torr), which can function to prevent any build up in pressure (e.g., resulting from the reduction reaction, from washing, from heating, from agitation, etc.). The system can optionally include a valve (e.g., a one way exhaust valve), which can function to vent the system when a pressure exceeds a target pressure.

The system can optionally include a computing system 300 (e.g., controller) which can function to control operation of the system (e.g., based on sensor readings). For example, the computing system can be used to control or modify one or more processing parameters (e.g., flow rate, material introduction timing, temperature, temperature profile, temperature fluctuation, temperature ramp, rotation speed, rotation speed profile, etc.). The computing system can include one or more: CPUs, GPUs, custom FPGA/ASICS, microprocessors, servers, cloud computing, and/or any other suitable components. The computing system can be local, remote, distributed, or otherwise arranged relative to any other system or module. In some variants, the computing system can include a PI controller, PID controller, optimal controllers (e.g., linear quadratic regulators, based on programs such as DIRCOL, SOCS, OTIS, GESOP/ASTOS, DITAN, PyGMO/PyKEP, RIOTS, DIDO, DIRECT, FALCON, GPOPS, PROPT, etc.), cascaded controllers (e.g., cascaded PID controllers), feed forward controller, predictive controller, fuzzy logic controller, artificial intelligence controller, and/or other suitable controllers, where the controllers can function to enable, improve, enhance, and/or otherwise maintain the chamber(s) at target property(s).

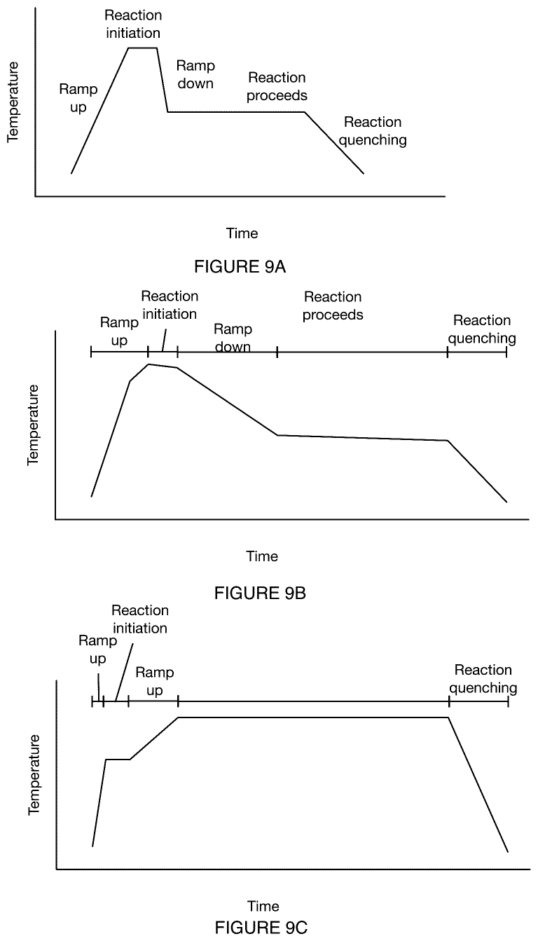

As a first illustrative example, a reaction chamber (e.g., reducing chamber) can be operated according to a target temperature profile. The temperature profile can include one or more intermediate temperatures along a reaction path. For instance (as shown in FIG. 9A, a reaction temperature profile can include ramping the temperature up to a reaction initiation temperature (e.g., 500-900° C. or values or ranges contained therein) for an initiation time (e.g., 10-60 minutes) and reducing (e.g., with forced cooling, ambient cooling, etc.) the material to a processing temperature (e.g., 300-600° C. or values or ranges contained therein) for a reaction processing time (e.g., 1-24 hours or values or ranges contained therein). In variations of this illustrative example (as shown for instance in FIG. 9B), the temperature profile can include a plurality of ramp up stages during to achieve the reaction initiation temperature (e.g., temperature ramp rate 1-10° C. until a temperature of about 500° C. followed by a temperature ramp rate of 0.1-5° C. until the initiation temperature is achieved), the initiation temperature and/or reaction processing temperature can be fixed or variable temperature (e.g., periods of gradual warming, cooling, and/or substantially constant temperature can be concomitant with the processing temperatures such as with a temperature slope less than about 1° C./min), and/or the temperature profile can otherwise achieve the target performance. In a second illustrative example (as shown for instance in FIG. 9C), the temperature profile can include a first temperature ramp culminating in a reaction initiation temperature (e.g., a static temperature, a temperature region with a slope≤1° C./min, etc.) followed by a second temperature ramp to a reaction temperature. Variations of this illustrative example can include more than two temperature ramps (e.g., more than one intermediate initiation temperature where intermediate temperatures can be associated with a positive or negative temperature change that is typically small such as ≤0.5° C./min).

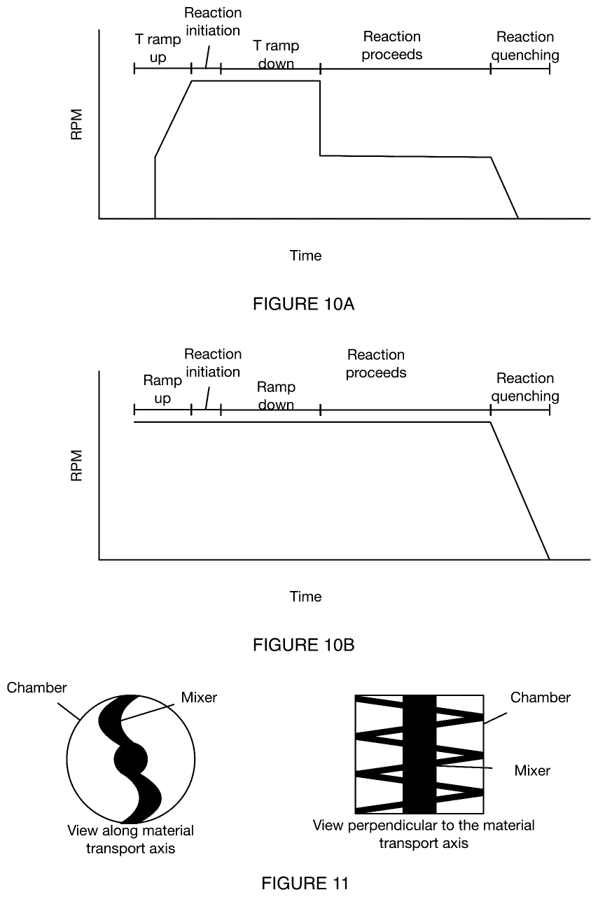

As a second illustrative example, a reaction chamber (e.g., reduction chamber, washing chamber, cold-welding chamber, milling chamber, etc.) can be operated according to an agitation profile. For instance (as shown for example in FIG. 10A or FIG. 10B with similar labels as those used in FIGS. 9A-9C for potential reaction stages), a chamber can be rotated according to revolution profile. The revolution profile can be constant and/or vary (e.g., depending on the chamber temperature, depending on the reaction stage, depending on the reaction progression such as measured by detecting a chamber composition, etc.). For instance, when the chamber is at a temperature greater than about 500° C., the chamber can be rotated at a rate between 100 and 1000 rpm. When the temperature is less than 500° C., the chamber can be rotated at a lower rate such as between about 10 and 500 rpm (e.g., to reduce wear, to reduce energy use, etc.). In these examples, rotation can refer to motion of the chamber, motion of an agitation mechanism within the chamber (e.g., motion of a blade, spiral mixer, etc.), a vortex motion of air flow within a chamber, and/or can refer to other suitable motion resulting in agitation of material within the chamber.

### 4. Method.

The method preferably functions to manufacture a silicon material (e.g., a material as described above; a silicon material as disclosed in U.S. patent application Ser. No. 17/322,487 titled ‘POROUS SILICON AND METHOD OF MANUFACTURE’ filed 17 May 2021 and/or U.S. patent application Ser. No. 17/525,769 titled “SILICON MATERIAL AND METHOD OF MANUFACTURE’ filed 12 Nov. 2021, each of which is incorporated in its entirety by this reference; etc.) from silica, but can additionally or alternatively be used to manufacture any suitable material. The method is preferably performed using a system or apparatus (e.g., a unitary system, self-contained system, etc.) as described above but can be implemented and/or performed in any suitable system.

The silica (e.g., silicon oxide, SiO₂, SiOₓ, etc.) starting material can be a waste material from another process (e.g., waste from an industrial process such as waste from silicon production), recycled material (e.g., recycled glass, recycled from other processes, etc.), pristine material, mined material (e.g., sand, diatoms, etc.), and/or any suitable silica material. Examples of silica starting materials include: sol-gel silica (e.g., silica prepared according to the Stöber method), fume silica, diatoms, glass, quartz, fumed silica, silica fumes, Cabosil fumed silica, aerosil fumed silica, sipernat silica, precipitated silica, silica gels, silica aerogels, decomposed silica gels, silica beads, silica sand, silicon halides (e.g., silicon chlorides, silicon fluorides, silicon bromide, silicon iodides, etc.), silane, TEOS, silicon pnictogens (e.g., silicon nitride, silicon phosphide, etc.), and/or any suitable silica and/or organic or inorganic silicon compounds.

The reagents (e.g., silica or silicon source material, reducing agent, salt, washing agent, etc.) used in the method can be added in solid, liquid, gas, plasma, and/or any suitable phase or state of matter. For instance, when magnesium is used as a reducing agent, magnesium can be introduced as a solid (e.g., to melt, sublimate, evaporate, etc. during the source material reduction), as a liquid, and/or as a gas (e.g., be vaporized before introducing in the reduction).

A yield of the process can depend on a repetition of steps (e.g., number of washes), local effects (e.g., local concentration of reagents; local temperature; local environment such as proximal a silica surface, proximal a silicon surface, etc.; local pressure; etc.), step parameters (e.g., temperature, time, pressure, atmosphere, etc.), system fill factor (e.g., amount of usable space occupied by reagents), system agitation (e.g., extent of mixing), reagent concentrations (e.g., relative silica to reducing agent concentration), and/or any suitable parameters or conditions of the process. As used herein, yield can be in terms of (e.g., relative to) silicon, silica, total starting reagents, and/or otherwise specified. For example, the manufacturing yield (e.g., in terms of silicon) is preferably greater than 80% (e.g., 80, 85, 90, 93, 95, 97, 99, 99.9, 100, values therebetween, i.e., the mass, volume, etc. of the final product is at least 80% silicon), but can be less than 80%. In another example, the manufacturing yield (e.g., as referenced to silica) is preferably greater than 30% (e.g., 30%, 32%, 33%, 35%, 37%, 38%, 39%, 40%, 41%, 42%, 45%, 46.5%, 46.7%, values therebetween, etc.; i.e., the mass, volume, etc. of the final product is at least 30% of the initial amount of silica), but can be less than 30%. The yield can refer to a mass yield, volume yield, stoichiometric yield, and/or any suitable yield. For example, a yield of 80% can mean that 80% of the starting mass of silicon is converted into the silicon material. However, the yield can otherwise be defined.

The method is preferably performed on a manufacturing scale (e.g., to produce greater than kilogram, tonne, megagram, etc. quantities of silicon material, to process greater than kilogram, tonne, megagram, etc. quantities of silica, etc.), but can be performed on a laboratory scale (e.g., subkilogram such as gram, milligram, microgram, etc. scales) and/or at any suitable scale. A challenge in achieving manufacturing scales can be achieving reproducible (e.g., repeatable, consistent, replicable, etc.) silicon materials between method instances. One benefit provided by variants of the method can be to enable a reproducible silicon material production. This benefit can be enabled, for instance, by: maintaining tight parameter control (e.g., parameter variance less than about 0.1%, 0.5%, 1%, 2%, 5%, 10%, etc. such as temperature, pressure, etc.), using pretreatment stages, by hindering local effects (e.g., local heating, local concentration gradients in reagents, etc. such as by continuously or regularly agitating the reagents, having well dispersed reagents, thin reagent, fill factor less than about 50%, etc.), by ensuring consistency in the starting materials (e.g., using preprocessing steps), modifying parameters or processes based on starting material properties, and/or in any manner.

Preparing the silica starting material S100 functions to preprocess the silica starting material to be reduced (e.g., in S200). S100 can be performed within a chamber of the system (e.g., a preparation chamber, preprocessing chamber, mixing chamber, reducing chamber, reaction chamber, etc.) and/or before the silica starting material has been introduced into the system.

Preparing the silica starting material can include: milling (e.g., grinding, mixing, etc.) the silica starting material, exposing the silica starting material to one or more reaction modifiers, measuring properties of the silica starting material, washing the silica starting material (e.g., using a solvent, using an acid wash, using a base wash, etc.), characterizing the silica starting material, and/or any suitable steps.

Milling the silica starting material can function to increase the size of the silica starting material, decrease the size of the silica starting material, change a surface of the silica starting material (e.g., decrease a surface area), change a morphology of the silica starting material (e.g., spherify the silica starting material), and/or can otherwise function. The silica starting material can be milled, for example, using a ball mill, shaker mills, planetary mills, attritors, uni-ball mills, IsaMills, rod mills, stamp mills, arrastras, pebble mills, SAG mills, AG mills, tower mills, Buhrstone mills, VSI mills, cryo mills, and/or any suitable mill and/or milling technique can be used. The silica starting material can be milled in isolation and/or with other reagents (e.g., reaction modifiers, solvent, dopants, etc.). The silica starting material can be milled at a milling speed between about 1-2500 rpm, at a milling speed less than 1 rpm and/or at a milling speed greater than 2500 rpm. However, the silica starting material can otherwise be milled.

In some variants, the silica starting material can be comminuted with, milled with, ground with, and/or otherwise be combined with other reaction modifiers (e.g., salt, reducing agent, etc.) which can improve a homogeneity of the mixture (e.g., thereby improving a reaction homogeneity and/or reproducibility in subsequent steps).

Exposing the silica starting material to one or more reaction modifiers functions to mix the silica starting material with one or more reaction modifiers. Reaction modifiers can include: thermal stabilizers (e.g., salts such as alkali metal halides, alkaline earth halides, etc.), reducing agents (e.g., alkali earth metals such as magnesium; transition metals; post-transition metals such as aluminium; alkali metals; etc.), dopants, coating agents (e.g., a coating agent such as used in S400, polymer, pitch, graphite, etc.), and/or any suitable reaction modifiers. The ratio (e.g., mass ratio, stoichiometric ratio, volumetric ratio, etc.) of reaction modifier to silica starting material can influence a yield, morphology, composition, surface area, porosity, and/or other properties of the silicon material. The ratio of reaction modifier to silica is preferably between about 0.1:1 and 10:1 (e.g., 0.1:1, 0.2:1, 0.3:1, 0.4:1, 0.5:1, 0.6:1, 0.7:1, 0.8:1, 0.9:1, 1:1, 2:1, 4:1, 8:1, values therebetween, etc.), but can be less than 0.1:1 or greater than 10:1. As an illustrative example, using a 1:0.83 ratio of silica to reducing agent (e.g., magnesium) can lead to a different reaction outcome than using 1:0.85 ratio of silica to reducing agent (e.g., magnesium). In this illustrative example, a greater relative quantity of reducing agent can lead to a lower reaction yield (e.g., due to formation of byproducts) and higher Si purity (e.g., more efficient removal of oxygen or other atoms from the silica starting material). However, the silicon material can be relatively insensitive to the reaction modifiers and/or otherwise depend on the reaction modifiers and/or silica starting material.

The reaction modifier can be added in a single aliquot, in a plurality of aliquots (e.g., in a “dropwise” manner, in predetermined mass, in predetermined volume, etc.), and/or in any suitable manner. The silica starting material can be exposed to a reaction modifier continuously, intermittently (e.g., added at predetermined times, frequencies, etc.), once, and/or with any suitable timing. The reaction modifier can be added quickly (e.g., within a threshold amount of time of starting the reaction, within a threshold amount of time of starting to add material, etc.), slowly (e.g., throughout the duration of the reduction reaction, over a threshold duration such as 1 min, 5 min, 10 min, 60 min, etc.), and/or with any suitable rate.

Exposing the silica starting material to a reaction modifier can include: milling (or grinding) the silica starting material with the reaction modifier(s), coating the silica starting material with the reaction modifier(s) (e.g., by dissolving the reaction modifier in a solvent, mixing the silica starting material with the dissolved reaction modifier, evaporating the solvent, etc.; physical coating; chemical coating; etc.), mixing the silica starting material and the reaction modifier, melting the reaction modifier (e.g., an mixing the molten reaction modifier with the silica starting material), vaporizing (e.g., evaporating, sublimating, etc.) the reaction modifier (e.g., and flowing the reaction modifier vapor over the silica starting material), and/or any suitable steps or methods for exposing the materials.

In a first specific example, the silica starting material can only be exposed to reducing agents (e.g., can not be exposed to a salt or other thermal stabilizer). The first specific example can be beneficial for reducing a complexity, number of, and/or other aspect of the method (particularly but not exclusively washing the silicon material). In a second specific example, the silica starting material can be exposed to reducing agents.

However, the silica starting material can be exposed to any suitable reaction modifiers.

Characterizing the silica starting material functions to determine one or more properties of the silica starting material. Examples of properties can include: particle size, particle size distribution, porosity, pore size, pore size distribution, dopant identity, dopant concentration, oxygenation, and/or any suitable properties. The properties can be used to set and/or modify other method steps (e.g., reduction parameters, coating parameters, washing parameters, etc.), used to modify silica starting material (e.g., determine an amount of reaction modifier to include with the silica starting material), and/or can otherwise be used. The properties can be determined using optical characterization (e.g., fluorescence, absorption, reflection, transmission, vibration, electronic, etc. spectroscopy), electron characterization (e.g., transmission electron microscopy, scanning electron microscopy, scanning transmission electron microscopy, electron energy loss spectroscopy, energy-dispersive x-ray spectroscopy, etc.), x-ray characterization (e.g., x-ray diffraction), thermogravimetric analysis, and/or any suitable characterization methods can be used.

In some variations of the method, the silica starting material can be prepared (e.g., exposed to the reaction modifier(s), milled, etc.) during (e.g., simultaneously with, contemporaneously with, concurrently with, etc.) the reduction of the silica starting material (i.e., S100 can be performed concurrently with, during, iteratively with, etc. S200). For instance, an initial dose of reaction modifier (e.g., reducing agent) can be introduced, with additional reaction modifier introduced at predetermined times, when reaction modifier concentration decreases below a threshold concentration, at predetermined temperatures, at predetermined pressures, and/or at any suitable time(s).

Reducing the silica starting material S200 functions to reduce the silica starting material to silicon material. The resulting silicon material preferably has substantially the same morphology and/or structure as the silica starting material (e.g., retains the same shape with a change in lattice constant and/or size commensurate with the change in lattice spacing between silica and silicon, be fused at points of contact between particles, have an identical appearance, etc.) but can have a different morphology and/or structure from the silica starting material (e.g., form shards, break, fuse, have different size or morphology, etc.). However, the resulting silicon can have any suitable morphology. The silica starting material is preferably reduced within the system (e.g., within a reaction chamber of the system, within a pretreatment chamber, within a reducing chamber, etc. preferably within a working volume of a chamber), but can be reduced in any suitable system.

During the silica starting material reduction, the pressure is preferably below atmospheric pressure. For example, the pressure (e.g., within the chamber) can be <1 Torr, 1 Torr, 10 Torr, 100 Torr, 200 Torr, 300 Torr, 500 Torr, 700 Torr, 725 Torr, 750 Torr, 760 Torr, values therebetween, etc.). However, the pressure can be greater than atmospheric pressure. In some variants, the pressure can be monitored and used to control parameters of the reduction (such as introducing of additional reducing agents, identification of an end to a pretreatment phase, identification of a start of a reduction, identification of an end of a reduction, initiate a change in temperature, etc.). However, the pressure can otherwise be used.

The silica starting material is preferably reduced without including salt(s) (or other thermal modifier(s)) in the reaction chamber. The absence of thermal modifiers can be enabled technologically by the use of agitation mechanisms to improve thermal homogeneity within the chamber (e.g., without requiring a thermal absorber, heat sink, etc.). However, salt (or other thermal modifier(s)) can be included (e.g., to further improve a thermal homogeneity of the reduction, particularly but not exclusively when the chamber is not agitated, rotated, etc.).

The reagents (e.g., silica starting material, silicon, reducing agent, thermal modifier, etc.) are preferably continuously agitated (e.g., according to an agitation profile) during the silica reduction. However, the reagents can be intermittently agitated, not agitated, and/or can otherwise be moved. The reagents can be agitated by an agitation mechanism (e.g., as discussed above), and/or using any suitable mechanism. The reagents are preferably agitated such that fragments (e.g., particles) of the silica starting material do not remain in contact with each other for greater than about 10 seconds (e.g., 1 ms, 10 ms, 100 ms, 1 s, 2 s, 5 s, 10 s, values therebetween, etc.), which can be beneficial for removing a need for thermal modifiers (e.g., function without including salts) and/or can minimize local heating or other local effects. However, the reagents can be agitated in any manner. For example, the reagents can be agitated in a turbulent manner. In another example, an agitation speed can be at least about 10 rpm (e.g., 100-1000 rpm); however, any suitable agitation speed can be used.

The reduction preferably occurs at a reduction temperature. The reduction temperature is preferably less than the melting temperature of the silica starting material and/or silicon, but can be equal to or greater than the melting temperature (e.g., without allowing the silica and/or silicon from equilibrating to the temperature, where the reagents are in equilibrium with said temperature for less than a threshold duration, etc.). The reduction temperature can be a temperature or range between about 300-1000° C. (such as 400° C., 500° C., 700° C., 800° C., 1000° C., values therebetween, etc.), less than 300° C., and/or greater than 1000° C. In some embodiments, the reduction temperature (e.g., the chamber temperature during the reduction reaction) can be reduced. For example, an RF source can be used to create a plasma (e.g., a low temperature plasma) within the chamber, which can enable a lower reduction temperature (e.g., room temperature, 0° C., 50° C., 100° C., 200° C., 300° C., 400° C., 500° C., 600° C., etc.) to be used.

The silica starting material can be maintained in the reducing conditions (e.g., within the reducing chambers) until a condition (e.g., equilibrium is achieved, target pressure, duration of time, etc.) is met. For example, a reducing time (duration of time) can be between 5 minutes and 24 hours. However, the reducing time can be greater than 24 hours, less than 5 minutes, and/or any suitable duration of time.

During the reduction, reducing agents (and/or other reaction modifiers) can optionally be added to the silica starting material (and/or other reagents). For example, reducing agent vapor (e.g., magnesium vapor) can be introduced into the reducing chamber during the reduction (e.g., until a target ratio of reducing agent to silicon or silica is achieved).

During the reduction, oxidation can be hindered (e.g., slowed, prevented, avoided, etc.), for instance, by performing the steps in an inert environment (e.g., argon or nitrogen). Additionally or alternatively, oxidation can also be implemented on purpose by adding control oxygen, water, or other oxidizers into the chamber (e.g., air) such as to achieve a target oxygen doping level.

Reducing the silica starting material is preferably performed in a multi-stage process, but can be performed in a single stage and/or any suitable number of stages. For example, a multi-stage process can include two stages, three stages, five stages, ten stages, and/or any suitable number of stages. The different stages can refer to different reduction temperatures, different reaction chambers, different reducing agent concentrations, different pressures, different fill fractions, different durations, different agitation speeds, different agitation mechanisms, and/or any suitable properties. In a specific example as shown for example in FIG. 8, a multi-stage reduction can include a pretreatment at a first temperature for a first duration and a reduction at a second temperature (preferably greater than the first temperature) for a second duration (which can be the same as, greater than, and/or less than the first duration). In a second specific example, as shown for instance in FIG. 9A or 9B, a multi-stage reduction can include a reaction initiation stage and a reaction progression stage (e.g., performed at a temperature lower than the reaction initiation to promote continued reaction while decreasing a risk of silicon melting, cross reactions between the reducing agent and silicon, etc.).

As an illustrative example of a multi-stage process, silica starting material (with reducing agent) can be heated (e.g., within a pretreatment chamber) to a temperature between about 500-700° C. (such as 500-550, 550-575, 550-600, 575-625, 600-650, 650-680, 680-685, 680-700, 700-705, 700-710, 700-720, etc.) for approximately 1 hour (e.g., between about 30 minutes and 2 hours). During the pretreatment, the reagents are preferably (but does not have to be) continuously agitated. After the duration, the reagents can be transferred to a holding chamber (which can be heated such as to about 300-700° C. or not heated such as at an ambient temperature, room temperature, etc.) where the reagents can be held for any suitable duration (e.g., until a reducing chamber is prepared for additional material) such as 0 minutes to 24 hours (e.g., without undergoing further reactions or changes). For instance, the reagents can be held for approximately 1 hour (the difference between the amount of time the reagents undergo pretreatment and being reduced). After the holding chamber, the reagents can be transferred to a reducing chamber, where the reagents can be heated to a reducing temperature between about 600-900° C. (e.g., 600-650, 630-675, 650-700, 700-750, 725-775, 775-825, 780-800, 785-790, 785-795, 790-795, 800-805, 800-810, 800-820, 800-850, 820-825, 850-900, 900-910, 900-920, etc.) for approximately 2 hours (e.g., between 1 hour and 3 hours). Throughout the reduction, the reagents are preferably (but do not have to be) continuously agitated. During the pretreatment, holding, and reduction, the reagents are preferably in an inert atmosphere (e.g., inert gas such as Argon). The environment can be shared (e.g., common environment) or separately contained (e.g., within each chamber a separate environment that is generally not shared can be maintained). The pressure within the chambers is preferably (but does not have to be) below atmospheric pressure (e.g., about 500 Torr, 700 Torr, 750 Torr, etc.). In variations of this specific example, the reagents can optionally include salt (e.g., sodium chloride, aluminium chloride, iron chloride, zinc chloride, alkali metal nitrates, alkaline earth nitrates, alkali metal halides, alkaline earth metal halides, alkali metal carbonates, alkaline earth metal carbonates, alkali metal oxides, alkaline earth metal oxides, etc.). In these variations, the agitation can be less essential (though still preferred) as the salt can function as a heat sink and/or otherwise function to hinder local heating effects and/or enhance thermal equilibration of the reagents.

As a second specific example of S200, the reagents (e.g., silica starting material, thermal modifiers, reducing agent, coating agent, etc.) can be heated homogeneously. For instance, the reagents can be heated in different temperature stages (e.g., to control the porosity of the resulting silicon material) such as first heating the reagents to a temperature between about 600-700° C. for 10 minutes to 2 hours to start or initiate the reaction followed by cooling the reagents to a temperature between about 300-500° C. and hold for between 1 hour and 24 hours. In some variations, initiation temperatures above 750° C. can be used (which can provide a technical advantage of increased silicon yield, lower porosity, etc.) and/or lower initiation temperatures (e.g., <500° C.) can be used (which can result in a technical advantage of higher porosity, higher oxygen content in the silicon material, etc.).

Processing the silicon S300 can function to process the silicon prepared in S200. S300 is typically performed after S200. However, S300 can be performed at the same time as S200 and/or with any suitable timing. S300 can be performed in stages (e.g., different processing steps can be performed sequentially) and/or in a single process. Each stage is typically performed in a separate chamber (e.g., separate processing chamber 130), but can be performed in the same chamber.

S300 can include washing the silicon S320, fusing the silicon S340, and/or other suitable steps.

Washing the silicon preferably functions to remove one or more byproducts and/or unreacted species (e.g., residual reducing agents, residual silica, salt, etc.) from the silica reduction (e.g., from S200), to purify the silicon material, and/or can otherwise function. In some embodiments, the washing steps can increase and/or introduce pores in the silicon (e.g., by etching or removing byproduct from the silicon). Byproducts can depend on the reducing agent, reducing temperature, ratio of reducing agent to silica, salt, and/or other suitable properties of the reagents. Exemplary byproducts include magnesium silicon materials (e.g., MgSi, Mg₂Si, etc.), aluminium silicon materials (e.g., Al₄Si₃), reducing agent silicides, reducing agent oxides (e.g., Al₂O₃, MgO, etc.), residual reagents that did not fully react, residual silicon oxide, thermal modifiers (and/or reaction products between the thermal modifiers and silicon or the reducing agent), and/or any suitable byproducts. The silicon is preferably washed in a washing chamber (e.g., connected to and distinct from the reduction chamber), but can be washed in a reduction chamber and/or any suitable chamber. After the silica is reduced, the resulting silicon (and other reagents and/or byproducts) is generally transferred to a holding chamber (e.g., the same or different from the holding chamber between reduction stages) until the washing chamber is ready. However, the silicon can be immediately transferred to the washing chamber, and/or washed with any suitable timing.

During the washing process, the silicon material is preferably continuously agitated (e.g., using an agitation mechanism). However, the silicon material can be intermittently and/or otherwise agitated during the washing process.

Washing the silicon can depend on whether salt is present or not. However, the washing process can be independent of the presence of the salt. For instance, when salts are not present, fewer washing steps can be necessary (e.g., solvent washes can be avoided).

Washing the silicon can include: exposing the silicon to one or more washing agents, heating the silicon to a washing temperature, recovering one or more wash products, and/or any suitable steps.

Exposing the silicon to one or more washing agents can function to dissolve and/or react one or more byproducts or residual reagents with the washing agents. The washing agents can be liquid, solid, gas, and/or any suitable phase. Washing agents can include: solvents (e.g., alcohols such as methanol, ethanol, isopropyl alcohol, etc.; water; ethers; organic acids; hydrocarbons such as hexane; cyclohydrocarbons such as cyclohexane; aromatic compounds such as toluene; etc.), acids (e.g., hydrofluoric acid, hydrochloric acid, hydrobromic acid, hydroiodic acid, nitric acid, sulfuric acid, etc.), bases (e.g., sodium hydroxide), and/or any suitable washing agents. In a specific example, a washing agent can include gaseous hydrochloric acid. In a variation of this specific example, the washing agent can include concentrated hydrochloric acid (e.g., 38% HCl solution in water). In this specific example and its variations, the HCl can convert oxides, silicides, and/or other species into chlorides (e.g., MgO converted into MgCl₂, Al₂O₃ into AlCl₃, MgₓSi into MgCl₂ and SiCl₄, etc.). The resulting chlorides can be separated from (e.g., washed, removed, etc.) the silicon material via heating (e.g., by heating to a temperature between a phase transition temperature of the chloride and a melting temperature of the silicon material), using solvents (e.g., water; alcohols such as methanol, ethanol, isopropyl alcohol, etc.; etc.), and/or can otherwise be washed or separated from the silicon material. In a second specific example, the washing agent can include isopropyl alcohol and/or water, which can be particularly beneficial for removing salt(s) from the silicon. However, any suitable washing agent can be used. The washing agents can be dehydrated (e.g., have a low water content such as less than 10% water by mass, by volume, etc.), deoxygenated (e.g., have a low dissolved oxygen content, hypoxic water, less than 2 mg/L oxygen, less than about 25% capacity oxygen relative to a maximum oxygen solubility in the solvent, etc.) and/or can otherwise be selected or processed (e.g., to reduce an oxidizing agent content in the washing agent which can be beneficial for hindering oxidation of the silicon material).

During washing step(s) that are exothermic (e.g., when HCl reacts with MgO, MgₓSi, etc.), the washing chamber is preferably cooled (e.g., actively cooled, passively cooled, etc.). The washing chamber can be cooled, for example, using ice, dry ice, liquid nitrogen, other cryogenic materials or solutions, a thermoelectric cooler (e.g., Peltier cooler), vapor compression refrigeration, a heat sink, fan cooling, and/or can be cooled in any manner. The cooling mechanism can be integrated into a wall of the chamber, added in the chamber (e.g., ice can be added directly into the chamber), in contact with the chamber (e.g., an outer wall of the chamber), and/or can otherwise be connected to the chamber. Cooling the washing chamber can refer to a temperature of the walls of the washing chamber, a temperature of the reagents (e.g., washing reagents, silicon material, byproducts, etc.), and/or to any suitable temperature. The cooling temperature can is preferably between about −200° C. and 0° C., but can be less than −200° C. or greater than 0° C.

The silicon is preferably washed using an excess of washing agents (e.g., a greater amount of washing agent than other reagents, in isolation or combination), but can be washed with a controlled amount of washing agents (e.g., matching such as stoichiometrically, by weight, by volume, etc. the reducing agent, silica, etc.) and/or with a dearth of washing agent(s).

The silicon can be washed once or a plurality of times. Each wash can use the same or different washing agent(s). Each wash can be for the same or a different duration of time. For example, a silicon material can be washed first using water (e.g., to dissolve and remove salt) followed by a hydrochloric acid wash (e.g., to convert byproducts into chlorides) followed by a water and/or isopropyl alcohol wash (e.g., to dissolve and remove the chlorides). However, any suitable washing step(s) can be performed.

Heating the silicon to a processing temperature can function to heat the silicon material to a temperature where the byproducts can undergo a phase transition (e.g., preferably without inducing a phase transition, annealing, etc. in the silicon). Heating the silicon (e.g., during washing) can additionally or alternatively function to burn off (e.g., remove) excess washing agents (e.g., burn off residual HCl), reduce the amount of solvent used in washing steps (which can reduce a cost and/or washing time), anneal a surface of the silicon material (e.g., melt or fuse an exterior surface of the silicon material, reduce an external surface area of the silicon material, etc.), melt the silicon (e.g., a surface of the silicon such as to promote fusion of silicon particles), and/or can otherwise function. For example, the silicon can be heated to approximately 800° C. (e.g., greater than about 714° C.; but preferably not hot enough to melt the silicon material) which can melt, vaporize, burn off, and/or otherwise remove some salts, magnesium chloride, and/or other byproducts from the silicon material. In this example, a wall (e.g., floor) of the washing chamber can be porous, mesh, or otherwise transferent to allow the phase-changed byproducts to separate from the silicon material. In this example, the byproducts can be collected and potentially recycled (e.g., reduced and/or oxidized to reform reagents for use in subsequent iterations of the method). For instance, the phase changed byproducts can be collected at (e.g., condense on, deposit on, freeze on, etc.) a cooler region of the chamber or a separate chamber. The collected materials can be discarded (e.g., as waste), recycled (e.g., back into reaction reagents such as reducing agents, washing agents, etc. such as to convert MgCl₂ or AiCl₃ into Mg or Al and HCl), can be reused (e.g., as another reagent such as MgCl₂ can be recycled as a salt or thermal modifier for another instance of the method or other reaction), and/or can otherwise be handled or processed. However, the silicon material can be washed at room temperature, ambient temperature, a washing temperature between about −200° C. and 1000° C., and/or at any suitable temperature.

Washing can include filtering (e.g., sieving) the silicon material which can facilitate separation of liquid (e.g., washing solvents, products dissolved in the solvent, etc.) from solid (e.g., the silicon material). Filtering can be beneficial for maintaining silicon particle uniformity, hindering material oxidation (e.g., by controlling the exposure of the silicon materials to oxidizing agents such as air), can increase reproducibility and/or yield, and/or can otherwise be beneficial.

Fusing the silicon material can function to reduce an external surface area of the silicon material (e.g., without substantially impacting an internal surface area of the silicon material, forming hollow silicon material, etc.), increase a particle size of the silicon material, modify a crystallinity of the silicon material, and/or can otherwise function. Fusing the silicon material preferably includes cold welding the silicon material (e.g., particles thereof) together. However, the silicon material can additionally or alternatively be fused using heat (e.g., by partially melting the silicon material), electrically, and/or in any manner.

Cold welding the silicon material is preferably performed using comminution (e.g., ball milling). However, the silicon material can be cold welded in any manner. During cold welding, the silicon material can be continuously comminuted and/or intermittently comminuted.

The silicon is preferably milled (e.g., comminuted) according to a set of milling properties (e.g., comminution properties). The set of milling properties can include: weight ratio (e.g., of balls to silicon material), milling speed, milling time, mill type, milling container, grinding medium (e.g., type, material, shape, size, size distribution, comminution medium, etc.), volume percentage of material filling in the container, milling temperature (e.g., comminution temperature), milling atmosphere (e.g., comminution atmosphere), milling agents (e.g., one or more chemicals added with the silicon during the milling process such as to enhance the milling process, to modify the resulting silicon, comminution agent, etc.), milling jar temperature, and/or any suitable properties. The milling properties can be selected based on target silicon properties (e.g., characteristic size, characteristic size distribution, shape, etc.), initial silicon properties (e.g., characteristic size, characteristic size distribution, shape, etc.), a target energy provided to the powder (e.g., the silicon and/or milling agents to be milled), a target amount of processing time, and/or otherwise be selected.

The weight ratio (e.g., the ratio between the weight of the balls and the weight of the silicon and/or other comminuted materials) is preferably between 1:1 and 250:1 (such as 5:1, 10:1, 20:1, 50:1, 100:1, 150:1, 200:1, etc.), but can be less than 1:1 or greater than 250:1. In general, higher weight ratios provide higher energy and shorter milling time to reach desired silicon properties. However, the weight ratio can be otherwise related or tuned in response to the target silicon properties.

The milling speed (e.g., comminution speed) is preferably a value or range between about 1-2500 rpm (e.g., 100, 200, 300, 400, 500, 600, 700, 800, 900, 1000, 1200, 1500, 1750, 2000, 2500, values or ranges therebetween, etc.), but less than 1 rpm or greater than 2500 rpm. In general, higher milling speed provides more energy to the powder (e.g., silicon, milling agents, etc.). As a first specific example, a silicon material can be milled (e.g., continuously milled) at about 900 rpm (e.g., 750-1000 rpm). As a second illustrative example, a silicon material can be milled (e.g., continuously milled, intermittently milled) at about 500 rpm (e.g., 350-600 rpm) which can be beneficial for scaling silicon material comminution (e.g., as larger mills can be more likely to be able to achieve slower milling speed). However, the milling speed can be otherwise related or tuned in response to the target silicon properties.

The milling time (e.g., comminution time) is preferably an amount or range of time between 1 min and 1000 hours (such as 1-24 hours), but can be less than 1 min or greater than 1000 hours. The milling time can be a contiguous milling time (e.g., a continuous milling time), a total milling time (e.g., including time spent not milling the material such as to allow the material to cool), a total amount of time that the mill is operable for (e.g., an amount of time that does not include periods of time that the mill is not operating), and/or any suitable time. When the powder is milled intermittently, the milling can be performed with a predetermined frequency, with a predetermined period, with random timing, according to a milling schedule, and/or with any suitable timing.

The silicon material is preferably comminuted continuously (e.g., without interruption); however, the silicon material can be comminuted intermittently (e.g., with interruptions). Whether a silicon material is comminuted with or without interruptions can depend on the silicon material, the comminution speed (e.g., higher speeds such as 900 rpm can favor continuous comminution, lower speeds such as 350 or 500 rpm can favor intermittent comminution, etc.), target comminuted silicon properties (e.g., characteristic size, void spaces, porosity, etc.), comminution temperature, and/or any suitable properties. As an illustrative example of an intermittent comminution, the silicon material can be comminuted for 1-10 minutes and then rested for 1-10 minutes (which can be beneficial for reducing a temperature of the silicon material and/or comminution container such as to prevent a heat build-up within the comminution container), repeated for a total time of 1-5 hours. Intermittent comminution can have a duty cycle between 1% and 99% (e.g., 1% of the time actively comminuting to 99% of the time with active comminution), and/or can have any suitable duty cycle. When the silicon is comminuted intermittently, the silicon is preferably comminuted for a greater amount of time that the silicon material is rested (e.g., not comminuted). For example, a silicon material can alternate between being comminuted for a comminution time (e.g., 10 min, 20 min, 30 min, 45 min, 60 min, 2 hr, 4 hr, 6 hr, 8 hr, 12 hr, 24 hr, values or ranges therebetween, etc.) and resting for a resting time (e.g., 1 min, 2 min, 3 min, 4 min, 5 min, 10 min, 15 min, 20 min, 30 min, 45 min, 60 min, 2 hr, 4 hr, 6 hr, 8 hr, 10 hr, 12 hr, 24 hr, values or ranges therebetween, etc.). Comminution and resting can be alternated a predetermined number of times (e.g., once, twice, thrice, 5×, 10×, etc.), until a target time has elapsed, until a target parameter is achieved (e.g., target temperature, target product release, etc.), until a target silicon material property (e.g., particle size, surface area, etc.), and/or until any suitable criteria is met. In an illustrative example, silicon particles can be comminuted for about 1 hour (e.g., 50-70 minutes), rested for about 3 minutes (e.g., 1-5 minutes). In this illustrative example, the total comminution time can be about 3 hours (e.g., 3 comminution and resting cycles). However, any suitable comminution parameters (e.g., comminution time, resting time, etc.) can be used.

Examples of mill types include: shaker mills, planetary mills, attritors, uni-ball mills, IsaMills, rod mills, stamp mills, arrastras, pebble mills, SAG mills, AG mills, tower mills, Buhrstone mills, VSI mills and/or any suitable mill and/or milling technique can be used.

The comminution chamber (e.g., milling container) can be made of or include: steel, including hardened steel, tool steel, hardened chromium steel, tempered steel, stainless steel, tungsten carbide cobalt (WC—Co), WC-lined steel, bearing steel, copper, titanium, sintered corundum, yttria-stabilized zirconia (YSZ), sapphire, agate, hard porcelain, silicon nitride (e.g., Si₃N₄), and/or any suitable materials. The comminution chamber can be the same or different from the reducing chamber.

The volume of the comminution container is preferably filled (e.g., with grinding medium, with powder, with additives, etc.) to a value or range between about 1-99% (e.g., 50%) of the total volume of the milling container, but the milling container can be less than 1% or greater than 99% filled.

The milling medium (e.g., comminution medium, milling medium, grinding medium, etc.) can be made of or include: hardened steel, tool steel, hardened chromium steel, tempered steel, stainless steel, tungsten (W), tungsten carbide (WC), tungsten carbide-cobalt (WC—Co), WC-lined steel, bearing steel, copper (Cu), titanium (Ti), sintered corundum, yttria-stabilized zirconia (YSZ), sapphire, agate, hard porcelain, silicon nitride (Si₃N₄), and/or any suitable material(s). Tungsten based comminution medium (e.g., milling medium) can be beneficial for avoiding or limiting an amount of introduced impurities and/or contaminants. However, any milling media can be suitable and/or beneficial (e.g., for having a lower cost). The size (e.g., radius, diameter, circumference, characteristic size, largest dimension, smallest dimension, etc.) of the grinding medium (e.g., grinding balls) is preferably a value or range between 100 nm and 10 cm (e.g., 100 nm, 300 nm, 500 nm, 1 μm, 3 μm, 5 μm, 10 μm, 30 μm, 50 μm, 100 μm, 300 μm, 500 μm, 1 mm, 3 mm, 5 mm, 10 mm, 30 mm, 50 mm, 100 mm, values or ranges therebetween, etc.), but can less than 100 nm or greater than 10 cm. The size distribution of the grinding medium can be a Dirac delta distribution, a normal distribution, a skewed distribution, an asymmetric distribution, a symmetric distribution, and/or have any suitable size distribution. The grinding medium is preferably ball shaped (e.g., spherical, spheroidal, etc.), but can be elliptical, ovate, polyhedral, and/or have any suitable shape. In an illustrative example, a zirconia jar can be used for the milling container and zirconia can be used as the milling media. In this illustrative example, zirconia can be used because it has a higher hardness than the silicon. However, any suitable material (e.g., with a higher or lower hardness than silicon) can be used.

Cold welding the silicon material is preferably performed at or below room temperature (e.g., at cryogenic temperatures). For example, the comminution temperature is preferably between about −200° C. to 200° C., but the milling temperature can be less than −200° C. or greater than 200° C. In general, higher temperature promotes or increase a diffusion rate (e.g., of the silicon material), which can increase a welding effect (e.g., fusion such as increasing a thickness of the exterior surface) and/or lead to larger particle sizes.

The comminution chamber (e.g., cold welding chamber, fusing chamber, processing chamber) is preferably cooled (e.g., in contact with a cooling system) during S340, which can function to enable a longer continuous milling time (e.g., without damaging the milling jar, the silicon material, etc.). The comminution container can be air cooled, water cooled (e.g., optionally including a freezing point depressant such as glycol), cryogenically cooled (e.g., using dry ice, a dry ice and acetone mixture, liquid nitrogen, liquid helium, liquid argon, liquid hydrogen, liquid methane, etc.), and/or can otherwise be cooled. For instance, the comminution container can be cooled to 20° C., 10° C., 0° C., −10° C., −20° C., −50° C., −100° C., −150° C., −200° C., −250° C., −270° C., temperatures or ranges therebetween, and/or to any suitable temperature. However, the comminution container can additionally or alternatively be heated (e.g., to enable finer control over the milling temperature; to achieve a comminution temperature above room temperature such as up to 100° C., a comminution temperature range between about −100 and 100° C., etc.; to enable sintering or melting of material within the mill; to facilitate PI, PD, PID, etc. control over the comminution temperature; etc.), and/or otherwise have any suitable temperature control (or lack thereof).

The comminution atmosphere (e.g., milling atmosphere) can be an inert atmosphere (e.g., includes helium, nitrogen, neon, krypton, argon, xenon, radon, carbon dioxide, or other gases that do not react with or have a low reaction with silicon and/or other materials), which can function to inhibit (or prevent) nitride, oxide, hydride, oxynitride, and/or other species formation; can include one or more reactive species (e.g., reactive nitrogen species, reactive oxygen species, oxygen, ozone, halogens, hydrogen, carbon monoxide, methane, ethane, ethene, ethyne, carbon sources, etc.); vacuum; and/or any suitable species. In variants where a reactive species is include, the reactive species can be used, to induce or form one or more of a nitride, oxide, hydride, oxynitride, and/or other species on or within the silicon material, to coat the silicon material (e.g., with a carbon coating such as a graphitic coating, amorphous carbon, to introduce carbon doping in the silicon material, etc.), and/or can otherwise be used.

A pressure of the comminution atmosphere is preferably less than standard pressure (e.g., less than about 760 Torr such as controlled using an exhaust, vacuum pump connected to an outlet, etc.) which can be beneficial for decreasing and/or accounting for pressure that is generated or built-up during milling.

In a specific example, fusing particles preferably includes cold welding the particles together (e.g., fusing the particles without liquid or molten material present at the point of contact; at a temperature below a melting temperature of silicon, carbon, comminuting agents, milling agents, etc.; etc.). Comminuting the silicon particles preferably does not lead to spherification of the silicon material. In some variants, this can be achieved by continuously comminuting the silicon material (e.g., without breaks during comminution). Preferably straight-edged silicon particles or materials (e.g., polyhedral shaped silicon particles) are formed. However, in some cases, it may be favorable to form, induce, and/or otherwise spherify the silicon particles (e.g., to form sacrificial particles, depending on an application, etc.). In these cases, spherification can be favored, for instance, by intermittent comminution (e.g., iteratively comminuting and not comminuting the silicon material for a first and second amount of time respectively until a total time, total comminution time, etc. has elapsed). However, spherificiation can otherwise be favored or avoided (e.g., by including particular comminution agents, based on a comminution temperature, based on a starting characteristic size, starting shape, starting size distribution, etc.).

Coating the silicon material S400 preferably functions to coat the silicon material with one or more coatings. The silicon material is preferably washed before being coated, but can be washed contemporaneously with coating (e.g., the washing agents can additionally function to form a coating material), and/or washed after coating (e.g., S400 can be performed before S300, a second instance of washing in a manner similar to or different from S300 can be performed after S400, etc.). In some variants, the silica starting material can be coated, where the coating can transfer and/or remain throughout processing to result in a coated silicon product (these variants can provide a technical advantage of activating the coating when activation is necessary as they can be activated by the reduction, processing, etc.). Between washing and coating the silicon material, the silicon material can be held in a holding chamber (e.g., to empty the washing chamber for additional silicon material to be washed), can be directly transferred to the coating chamber, can be held in the washing chamber, and/or can otherwise be handled. The washed silicon can be held (e.g., to be coated) for any length of time (e.g., minutes, hours, days, weeks, months, years, etc.) before being coated and/or further used (e.g., integrated into an application while uncoated).

During the coating process, the silicon material is preferably continuously agitated (e.g., using an agitation mechanism) which can be beneficial for achieving a substantially uniform or homogeneous coating. However, the silicon material can be intermittently and/or otherwise agitated during the coating process.

The coatings can function to modify (e.g., tune, improve, change, decrease, etc.) a physical, chemical, electrical, and/or other properties of the silicon material. The coating is preferably disposed on the external surface of the silicon material, but can additionally or alternatively be formed on an internal surface of the silicon material (e.g., partially or fully fill a void space of the silicon material. The coating is preferably homogeneous (e.g., substantially uniform surface coverage; substantially uniform thickness such as varies by at most 1%, 2%, 5%, 10%, 20%, etc. across the silicon material; etc.), but can be inhomogeneous (e.g., patterned, on a given particle, between particles, on a given cluster, between clusters, on an agglomer, between different agglomers, etc.).

The coating thickness is preferably a value or range thereof preferably between about 0.3-10 nm such as 0.3 nm, 0.345 nm, 0.7 nm, 1 nm, 2 nm, 2.5 nm, 3 nm, 4 nm, 5 nm, 6 nm, 7 nm, 8 nm, 9 nm, 10 nm, and/or values therebetween. However, the coating thickness can be less than 0.3 nm or greater than 10 nm. The coating thickness can be substantially the same and/or vary over the extent of the silicon material. The coating thickness can be chosen to allow ions (e.g., Li⁺ ions) and/or other materials (e.g., electrolytes) to penetrate the coating, to be impenetrable to ions, can include one or more pores and/or perforations to enable the materials to pass through (e.g., at predetermined locations), and/or electrolyte and/or otherwise be permeable to one or more substances. The coating thickness can depend on the coating material, the silicon material (e.g., the dopant concentration, the stabilizing material concentration, the dopant material, the stabilizing agent material, thickness of a stabilizing agent layer or layer that includes stabilizing agent, etc.), a target anode property of the silicon material (e.g., capacity), a target application of the silicon material, and/or otherwise depend on the silicon material.

The coating material is preferably carbonaceous, but can additionally or alternatively include metal (e.g., lithium, sodium, magnesium, etc.), oxides (e.g., SiOₓ), inorganic polymers (e.g., polysiloxane), metallopolymers, and/or any suitable materials. Examples of carbonaceous materials include: organic molecules, polymers (e.g., polyethylene (PE), polypropylene (PP), polyvinyl chloride (PVC), polystyrene (PS), polyurethane (PU), polyamide, polyacrylonitrile (PAN), polyacrylamide, polylactic acid, polyethylene terephthalate (PET), phenolic resin, polypyrrole, polyphenylene vinylene, polyacetylenes, polyfluorene, polyphenylene, polypyrene, polyazulene, polynapthalene, polycarbazole, polyindole, polyazepine, polyaniline, polythiophene, polyphenylene sulphide, poly(3,4-ethylenedioxythiophene), recycled polymers, pich, etc.); inorganic carbon (e.g., amorphous carbon, charcoal, diamond, graphite, graphene, graphene oxide, nanorods, carbon nanotubes, etc.), and/or any suitable carbonaceous materials.

S400 can include coating the silicon material using one or more of: chemical vapor deposition (CVD such as plasma enhanced CVD, etc.), sputter coating, atomic layer deposition, polymerization, carbonization, mixing, growth, precursor reduction, chemical or physical interactions, spin coating, drop coating, and/or other coating methods can be used. The coating process preferably maintains a concentration and/or quantity of reagents (e.g., carbon source, lithium source, oxidizing agent, etc.) to maintain a predetermined or target coating parameter. Examples of coating parameters include coating to silicon ratio, coating thickness, coating uniformity, coating material, electrical conductivity, mechanical properties, and/or any suitable coating parameters. For example, the target carbon to silicon ratio, for a carbonaceous coating, is preferably about 1:8, but can be any ratio (e.g., a ratio that depends on an oxygen content within the silicon material).

During material coating, the silicon material is preferably heated to a target coating temperature (e.g., 100-900° C.) before coating agents (e.g., carbon source such as polymers, methane, ethane, ethylene, etc.) are introduced. The silicon material preferably equilibrates at the coating temperature, which can be beneficial for achieving a target coating uniformity. However, the silicon can additionally or alternatively be at the coating temperature for a predetermined time (e.g., 5 min, 10 min, 20 min, 30 min, 45 min, 60 min, 120 min, 180 min, 240 min, 300 min, 600 min, etc.), until a target chamber property is achieved (e.g., temperature, pressure, humidity, etc.), and/or can otherwise be maintained at the coating temperature before coating agents are introduced. However, the coating agents can be introduced before and/or during this heating step.

In some variants, the coating can be activated (e.g., carbonized). These variants are particularly beneficial when non-electrically conductive coating material(s) are used as these variants can produce soft and/or hard carbon coatings and/or otherwise result in coatings with enhanced electrical conductivity. For instance, the coatings can be carbonized by heating to a temperature greater than about 500° C. However, the coatings can otherwise be carbonized.

During S400, the silicon material is preferably agitated (e.g., using an agitation mechanism, using a rotating barrel, using a spinning barrel, using a fluidized bed, etc.). The agitation during coating can be beneficial to avoid or decrease a tendency of the silicon materials (e.g., particles thereof) to stick together, increase a uniformity or homogeneity of the coating, and/or can otherwise be beneficial.

In a specific example, the silicon material can be coated in a manner as disclosed in and/or with a coating as disclosed in U.S. patent application Ser. No. 17/890,863 titled ‘SILICON MATERIAL AND METHOD OF MANUFACTURE’ filed 18 Aug. 2022, which is incorporated in its entirety by this reference.

In a first specific example, a method can include in a unified machine: heating porous silica particles and a reducing agent to a threshold reaction temperature, wherein the porous silica particle and the reducing agent are heated to the threshold temperature in stages, wherein in a first stage of the stages a temperature ramp rate is between 5 and 20° C./min and in a second stage of the stages the temperature ramp rate is between 0.5 and 2° C./min, wherein the first stage occurs until the porous silica particle and the reducing agent achieve a staged temperature after which the second stage occurs; maintaining the porous silica particle and the reducing agent at the threshold reaction temperature for a reaction initiation time; after the reaction initiation time, cooling the porous silica particle and the reducing agent to a second reaction temperature that is lower than the threshold reaction temperature for a reaction process time that is longer than the reaction initiation time; and after the reaction process time, washing silicon particles formed from the porous silica particle to remove oxidized reducing agent and species formed from silicon and the reducing agent; where the porous silica precursor and the reducing agent are continuously agitated during one or more steps of the method. In variations of the first illustrative example, heating the porous silica precursor and the reducing agent can include heating salt. In variations of the first illustrative example, prior to introducing the porous silica precursor, the reducing agent, and the salt into the unified machine; the porous silica precursor, the reducing agent, and the salt can be milled to produce a homogeneous mixture. In variations of the first illustrative example, continuously agitating the porous silica precursor and the reducing agent can include agitating the porous silica precursor and the reducing agent using a spiral powder mixer. In variations of the first illustrative example, washing the silicon can include washing the silicon with hydrogen chloride at a temperature below 0° C. In variations of the first illustrative example, wherein the threshold reaction temperature is between 500 and 750° C., wherein the staged temperature is between 400 and 500° C., wherein the second reaction temperature is between 300 and 500° C., wherein the reaction initiation time is between 10 minutes and 60 minutes, and wherein the reaction process time is between 2 and 12 hours. In variations of the first illustrative example, the porous silica precursor can include fumed silica. In variations of the first illustrative example, wherein steps excluding washing can be performed in a first chamber of the unified machine, and washing steps can be performed in a second chamber of the unified machine, where materials in the first chamber can be transferred to the second chamber. In variations of the first illustrative example, the unified machine further can include a ball mill downstream of the second chamber, wherein the silicon can be cold welded in the ball mall. In variations of the first illustrative example, cooling the porous silica precursor and the reducing agent can include forced cooling the porous silica precursor and the reducing agent.

In a second illustrative example, a system can include a reduction chamber configured to: receive a mixture comprising silica particles and a reducing agent; continuously agitate the mixture while heating the mixture to a threshold temperature; and maintain the threshold temperature for a threshold time; and a washing chamber configured to: remove oxidized reducing agent and inorganic compounds of silicon and the reducing agent from silicon particles formed in the reduction chamber. In variations of the second illustrative example, the washing chamber can be connected to the reduction chamber by a holding chamber. In variations of the second illustrative example, the reduction chamber and the washing chamber can be the same. In variations of the second illustrative example, the system can include a milling chamber wherein the mixture is milled to produce a homogeneous mixture prior to being received by the reduction chamber. In variations of the second illustrative example, the system can include a ball milling chamber, wherein the silicon particles are cold welded in the ball milling chamber by ball milling the silicon particles at a rate between 300 rpm and 500 rpm with a milling volume fill ratio of about 50% and a weight ratio of milling media to silicon particles between 10:1 and 220:1. In variations of the second illustrative example, the reduction chamber can be configured to continuously agitate the mixture by rotating the mixture at a rotation speed between 100 and 1000 rpm. In variations of the second illustrative example, the rotation speed can be controlled by a controller, wherein the controller controls the rotation speed according to a rotation speed profile, wherein the rotation speed profile is nonconstant, wherein the rotation speed profile can include higher rotation speeds when the mixture is at a higher temperature. In variations of the second illustrative example, the washing chamber can be configured to remove the oxidized reducing agent and the inorganic compounds from the silicon particles using gaseous hydrogen chloride, wherein the washing chamber is cooled to a temperature less than about 0° C. In variations of the second illustrative example, an instantaneous temperature of the reducing chamber can be controlled by a controller, wherein the controller programs the instantaneous temperature according to a temperature profile, wherein the temperature profile achieves a maximum of the threshold temperature before allowing the instantaneous temperature to decrease to a holding temperature. In variations of the second illustrative example, the reduction chamber and the washing chamber can cooperatively form a continuous spinning tube-based machine.

The methods of the preferred embodiment and variations thereof can be embodied and/or implemented at least in part as a machine configured to receive a computer-readable medium storing computer-readable instructions. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising: in a unified machine:
a) heating porous silica particles and a reducing agent to a threshold reaction temperature, wherein the porous silica particle and the reducing agent are heated to the threshold temperature in stages, wherein in a first stage of the stages a temperature ramp rate is between 5 and 20° C./min and in a second stage of the stages the temperature ramp rate is between 0.5 and 2° C./min, wherein the first stage occurs until the porous silica particle and the reducing agent achieve a staged temperature after which the second stage occurs;
b) maintaining the porous silica particle and the reducing agent at the threshold reaction temperature for a reaction initiation time;
c) after the reaction initiation time, cooling the porous silica particle and the reducing agent to a second reaction temperature that is lower than the threshold reaction temperature for a reaction process time that is longer than the reaction initiation time; and
d) after the reaction process time, washing silicon particles formed from the porous silica particle to remove oxidized reducing agent and species formed from silicon and the reducing agent;
wherein during steps a)-c) the porous silica precursor and the reducing agent are continuously agitated.

2. The method of claim 1, wherein heating the porous silica precursor and the reducing agent further comprises heating salt.

3. The method of claim 2, wherein prior to introducing the porous silica precursor, the reducing agent, and the salt into the unified machine; the porous silica precursor, the reducing agent, and the salt are milled to produce a homogeneous mixture.

4. The method of claim 1, wherein continuously agitating the porous silica precursor and the reducing agent comprises agitating the porous silica precursor and the reducing agent using a spiral powder mixer.

5. The method of claim 1, wherein washing the silicon comprises washing the silicon with hydrogen chloride at a temperature below 0° C.

6. The method of claim 1, wherein the threshold reaction temperature is between 500 and 750° C., wherein the staged temperature is between 400 and 500° C., wherein the second reaction temperature is between 300 and 500° C., wherein the reaction initiation time is between 10 minutes and 60 minutes, and wherein the reaction process time is between 2 and 12 hours.

7. The method of claim 1, wherein the porous silica precursor comprises fumed silica.

8. The method of claim 1, wherein steps a)-c) are performed in a first chamber of the unified machine, wherein step d) is performed in a second chamber of the unified machine, wherein between steps c) and d) materials in the first chamber are transferred to the second chamber.

9. The method of claim 8, wherein the unified machine further comprises a ball mill downstream of the second chamber, wherein the silicon is cold welded in the ball mall.

10. The method of claim 1, cooling the porous silica precursor and the reducing agent comprises forced cooling the porous silica precursor and the reducing agent.

11. A system comprising:
a reduction chamber configured to:
receive a mixture comprising silica particles and a reducing agent;
continuously agitate the mixture while heating the mixture to a threshold temperature; and
maintain the threshold temperature for a threshold time; and
a washing chamber configured to:
remove oxidized reducing agent and inorganic compounds of silicon and the reducing agent from silicon particles formed in the reduction chamber.

12. The system of claim 11, wherein the washing chamber is connected to the reduction chamber by a holding chamber.

13. The system of claim 11, wherein the reduction chamber and the washing chamber are the same.

14. The system of claim 11, further comprising a milling chamber wherein the mixture is milled to produce a homogeneous mixture prior to being received by the reduction chamber.

15. The system of claim 11, further comprising a ball milling chamber, wherein the silicon particles are cold welded in the ball milling chamber by ball milling the silicon particles at a rate between 300 rpm and 500 rpm with a milling volume fill ratio of about 50% and a weight ratio of milling media to silicon particles between 10:1 and 220:1.

16. The system of claim 11, wherein the reduction chamber is configured to continuously agitate the mixture by rotating the mixture at a rotation speed between 100 and 1000 rpm.

17. The system of claim 16, wherein the rotation speed is controlled by a controller, wherein the controller controls the rotation speed according to a rotation speed profile, wherein the rotation speed profile is nonconstant, wherein the rotation speed profile comprises higher rotation speeds when the mixture is at a higher temperature.

18. The system of claim 11, wherein the washing chamber is configured to remove the oxidized reducing agent and the inorganic compounds from the silicon particles using gaseous hydrogen chloride, wherein the washing chamber is cooled to a temperature less than about 0° C.

19. The system of claim 11, wherein an instantaneous temperature of the reducing chamber is controlled by a controller, wherein the controller programs the instantaneous temperature according to a temperature profile, wherein the temperature profile achieves a maximum of the threshold temperature before allowing the instantaneous temperature to decrease to a holding temperature.

20. The system of claim 11, wherein the reduction chamber and the washing chamber cooperatively form a continuous spinning tube-based machine.
